(19) United States
(12) Patent Application Publication
(10) Pub. No.: US 2025/0368197 A1
(43) Pub. Date: Dec. 4, 2025

(54) VEHICLE TESTING APPARATUS FOR FULL VEHICLE PERFORMANCE TESTING AS WELL AS VEHICLE TESTING OF INDIVIDUAL ON-BOARD SYSTEMS/SOFTWARE, SENSORS AND COMBINATIONS OF SENSORS, AND METHOD THEREOF

(71) Applicant: Swiss Reinsurance Company Ltd., Zürich (CH)

(72) Inventors: Luigi DI LILLO, Oberhasli (CH); Margherita ATZEI, Zürich (CH); Alessandro GIANFELICI, Mailand (IT)

(73) Assignee: Swiss Reinsurance Company Ltd., Zürich (CH)

(21) Appl. No.: 18/876,441

(22) PCT Filed: Jul. 6, 2023
(86) PCT No.: PCT/EP2023/068739

§ 371 Date: Dec. 18, 2024

(30) Foreign Application Priority Data
Jul. 21, 2022 (CH) CH000874/2022

(51) Int. Cl. B60W 30/095; B60W 50/00; G01C 21/28; G06Q 40/08; G07C 5/02

(52) U.S. Cl. CPC B60W 30/0956; B60W 50/0097; G01C 21/28; G07C 5/02; B60W 2050/0025; B60W 2050/0031; B60W 2420/403; B60W 2420/408; B60W 2420/54; B60W 2556/10; G06Q 40/08

(57) ABSTRACT

A system for accidentology-based measuring of accident risk-indexing score values for a motor vehicle to be tested providing a measured accident probability value for an occurrence of an accident event having a physical impact to the tested motor vehicle. The system includes a driving scenario module, a test setting module, and a scoring module. The driving scenario module is configured for determining various driving scenarios for the motor vehicle by defining a set of measurable scenario characteristics, which include at least one ADAS variable. The test setting module is configured for determining a test setting in form of a multi-dimensional test matrix, which includes testing protocols for each of the measurable scenario characteristics for providing measured values of measurable scenario characteristics of the various driving scenarios. The scoring module is configured for generating the risk-indexing score by receiving the multi-dimensional test result signal and a historical data information signal.

### FIELD OF THE INVENTION

The present invention relates to the field of vehicle testing and risk assessment for at least partially autonomously operated vehicles, in particular to the field of indicating an accident probability value as a risk value for an occurrence of an accident event having a physical impact with a measurable damage to the vehicle and/or to a driver of said vehicle. More particular, the present invention relates to the field of testing a driving behavior of a vehicle provided with an Advanced Driver Assistance System (ADAS) for indicating an accident probability value of such ADAS vehicle. Further, the present invention relates to the field of risk-transfer and risk-measuring technology, providing the technical means for measuring of an accident probability value providing a risk score measures in particular measuring and capturing an actual accident impact considering an activated ADAS. The risk assessment of at least partially autonomously operated vehicles is inter alia applicable for providing ADAS vehicle testing as a service and projecting a risk-transfer pricing structure for the insurance industry as well as for vehicle manufacturers.

### BACKGROUND OF THE INVENTION

Every year more than one million deaths and docents of millions of serious injuries occur due to vehicle accidents worldwide. One way to prevent automobile accidents is to design systems that assist the driver in emergency maneuvers. Unfortunately, there are view prior art systems and facilities where these systems can be tested using full-size automobiles. An alternative to expensive and potentially dangerous full-size testing is scale-model testing. However, up-to-now, there are no reliable scale-modelling systems that scale-model structure are suitable alternatives to tests with full-size equipment.

It is again to be noted, that the impact of vehicle accidents, world-wide, is a severe problem. Crash injuries are estimated to be the eighth leading cause of death globally for all age groups and the leading cause of death for children and young people 5-29 years of age. According to the US centers for disease control and prevention, it is expected that fatal and nonfatal vehicle injuries will cost the world economy approximately $1.8 trillion US dollars per year. At the same time, vehicles are objects of risk transfer technology and insurance systems covering a risk of a physical damage of accident events in return to the payment of an insurance premium. Such a risk-transfer premium is generally based on a monetary loss measure representing a potential level of physical damage and on an accident probability measure, which are combined to indicate a risk value or risk score for the occurrence of an accident event having a measurable damage to a vehicle and/or a driver. The higher the probability of an accident and an associated potential damage the higher the premium needs to be set.

In an effort to reduce the numbers of accidents and to lower their negative impacts passive safety systems (PSS), like seatbelts, airbags, etc., are known for a long time. Over the last few decades active safety systems in form of driving assistance and vehicle safety automation systems are a vastly growing field. For example, Advanced Driver Assistance Systems (ADAS) have become effective accident prevention means by executing partially autonomous driving control and are a fundamental cornerstone towards fully autonomous vehicle driving systems. ADAS is developed to provide partial automation to the vehicle and aims to increase drivers' comfort and safety by informing, warning and actively supporting guidance and stabilization of the vehicle. ADAS combines a plurality of complex technological systems for example addressing driving comfort, safe driving assistance, traffic assistance, lateral motion control, and longitudinal motion control. For example, an ADAS equipped vehicle can comprise intelligent vehicle systems for adaptive cruise control, automatic parking, collision avoidance, lane change assistance, and many others. As a consequence ADAS reduces the risk exposure of a driver, for example by providing a warning of driving over the speed limit, by raising driver alertness or triggering control tasks which takes over the vehicle control to eliminate many of the driver errors leading to accidents, by preventing driving under the influence of alcohol, and by assisting in a better control of the vehicle (e.g., improving visibility of the road environment). ADAS features and functions can be achieved through either an autonomous approach using on board systems and wayside systems, or cooperative approach relying on interfaces between a vehicle and other vehicles on the road and road system components.

Despite many advantages of ADAS there are also drawbacks for a safe driving behavior and consequently a negative impact on the measured accident avoidance rate and an associated risk measure. For example, drivers shift their attention to distractions alongside of the road that causes insufficient attention to the driving tasks, or drivers get frustrated with warning systems due to unnecessary frequent system warnings or when certain elements of the driving tasks are taken over by the system in contrast to a driver's desire. A study of Jonas Bärgman and Trent Victor (doi: 10.1049/iet-its.2018.5550) assessing the off-road glance behavior of drivers using ADAS vehicles has shown that the safety benefit of forward collision warning and autonomous emergency braking, in combination with adaptive cruise control and driver assist systems, may almost completely dominate the safety impact of longer off-road glances that an activated ADAS may induce. However, not all vehicles are equipped with all of these ADAS features and drivers can activate and deactivate specific functions of the ADAS features, which may reduce the safety benefits as described in the study.

In addition to these relatively new safety automation systems and advanced driving assistance systems the driving behavior and risk of accident involvement depends on other factors traditionally considered for the assessment of risk scores. Traditional risk estimations and assessments are mainly based on human expert opinion and/or employ statistically based structures based on risk class factors like age, gender, marital status, place of residence, number of driving years, driving history or credit history of the driver or vehicle characteristics like model, year, engine characteristics and vehicle type. In state of the art risk transfer systems drivers who, for example, claim a residence in a larger metropolitan area run a higher risk of being involved in an accident based on the logic that cities are congested with much more traffic than urban areas. If a driver has any type of driving violation attached to his driving history, the driver will be rated to a higher risk-transfer rate than someone whose driving record has no infractions. Women drivers, married drivers and single parents are usually considered as a lower risk in general. Newer vehicles are going to require more coverage than a second-hand vehicle, sports cars are expensive to manufacture which is why they are expensive to repair in case of an accident, and the like. In general, vehicles that have a lesser value will cost less to transfer their risks.

The impact and effectiveness of ADAS features on the driver's risk or risk score of getting involved in an accident is not considered in most prior-art risk assessment systems. The systems are not designed to physically measure the impact of the activation or deactivation of an ADAS features on the measured overall probability of an accident event to occur. The effective impacts of ADAS features are not measured and thus are not reflected in most prior art vehicle risk-transfer assessment systems and a possible consecutive premium pricings. On one hand this is due to the applied statistical risk measuring structures, which have been mainly designed around demographic variables as well as basic vehicle characteristics, e.g., vehicle type, engine displacement, engine power. On the other hand not all autonomous or partially autonomous vehicles are the same which excludes using a standardized risk assessment method in a systematic and consistent manner. There are three main reasons: (1) it is difficult to know what version of ADAS features are installed in a given vehicle, since modern vehicles can be updated with new or improved ADAS functionalities and access to detailed car/build data or on-board systems could be required, (2) technical developments and advancements in the field of ADAS functions are rapidly progressing and differ widely between vehicle manufactures and vehicle models, and (3) it is difficult to propagate the impact of ADAS features in terms of claims frequency and severity, since this requires deep and frequent interactions with automotive partners. In order to design a correct assessment methodology and capture the ADAS effectiveness in a risk-measuring and risk-transfer context, it would be necessary to get access to technical build data and understanding how the technology works. However, this level of technical details is usually kept confidential and improved updated versions of ADAS functions are quickly implemented and installed in modern driving systems. Such fast technical advancements make it impossible to acquire statistically significant assessments for profound determination of risk scores for ADAS controlled vehicles.

US 2015/242953 A1 discloses an example of a prior art system providing risk assessment and insurance coverage for autonomous vehicles. In particular, the risk assessment is directed to determine autonomous vehicle reliability and associated risks. However, the risk assessment is focused on the operational reliability and not to risk, associated with the autonomous car in the traffic.

US 2015/0187019 A1, filed by the Hartford Fire Insurance Company, discloses a system for assessing risks and generating insurance premiums associated with cars. In particular, it discloses a system based on telematics data to control the use of autonomous features built in the car. The premium is determined based on the captured data. However, in the risk assessment is focused on the use of the autonomous features by the driver, assuming, that the use of these features reduces the risk during driving. US 2015/0187013 A1, filed by Hartford Fire Insurance Company, shows a system for risk assessment and premium determination based at least partially upon captured telematics data. A discrete risk segments is determined by the use of the vehicle(s) based upon a driver signature associated with each of the discrete segments. However, this system is focused on the risk assessment based on captured biographical data.

U.S. Pat. No. 10,783,725 B1 discloses a system assessing a risk score in the context of vehicles equipped with ADAS features by detecting operator reliance to vehicle alerts. The system receives user profile data of an operator that includes a baseline of at least one driving activity aided by activation of an alert from a feature of an Advanced Driver Assistance System (ADAS). Further, the system receives historical ADAS alert frequency data including a history of at least one driving activity aided by activation of the alert from the ADAS feature. The system then compares the user profile data with the historical ADAS alert frequency data, determines a reliance level based upon the comparison, and sets a portion of an operator profile of the vehicle with the reliance level. As a result, a risk averse driver, and/or proper responsiveness to vehicle alerts can be rewarded with insurance-cost savings, such as increased discounts based on the generated ADAS risk score. However, the system solely allows to consider operator's behavior of the vehicle in respect to possible ADAS features' alarm.

In summary, a lot in safety technology is not properly considered by the prior art systems in the risk-transfer technology and measuring systems. The inventive ADAS risk score bridges the gap and provides the risk-transfer technology with the missing piece of information thanks to a scientific-based and technological-based methodology.

### SUMMARY OF THE INVENTION

It is one object of the present invention to provide an electronic risk scoring system for measuring a risk-indexing score indicating an accident probability value for an occurrence of an accident event having a physical impact with a measurable damage to a vehicle provided with an Advanced Driver Assistance System (ADAS) and/or a driver of such vehicle, which provides precise risk score measurement incorporating up to date ADAS functionalities as well as driver characteristics and/or environmental conditions, simplifies risk score assessment in real-time and allows for customized risk determination acknowledging individual vehicle, driver and/or surrounding conditions. It is an object of the present invention to extend the existing technology to provide a technical structure to allow implementation of quantified analysis of ADAS functionality contribution to risk prevention and prediction with defined metrics and/or measures, to allow for dynamic adjustment of the metrics and/or measures in view of technical advancements, to create a reproducible and comparable risk score assessment that relies on technical measurements and process control, and to provide a way to technically capture and manage a risk assessment of ADAS vehicles that optimizes risk-transfer operation based on standardized risk evaluation.

Further, it is an object of the present invention to provide a risk scoring measuring method for measuring a risk-indexing score indicating an accident probability value for an occurrence of an accident event having a physical impact with a measurable damage to a vehicle provided with an Advanced Driver Assistance System (ADAS) and/or a driver of said vehicle that provides a reproducible assessment process for measuring the risk-indexing score, enables a real-time, dynamic measurement process for measuring ADAS functionalities, environmental or operational parameters of ADAS vehicles, in particular allowing an automated risk-transfer process for adaptable risk-transfer profiles based on measuring and capturing risk related vehicle parameters and driving behavior information based on reproducible testing procedures and providing a technically scalable process for risk-score assessment and risk-transfer optimization.

According to the present invention, these objects are achieved, particularly, with the features of the independent claims. In addition, further advantageous embodiments can be derived from the dependent claims and the related descriptions.

According to the present invention, the above-mentioned objects are solved by an electronic risk scoring system and method for measuring a risk-indexing score indicating an accident probability value, i.e. a risk value, for an occurrence of an accident event having a physical impact with a measurable damage to a vehicle provided with an Advanced Driver Assistance System (ADAS) and/or to a driver of said vehicle. The electronic risk scoring system at least comprises a driving testing system, an accident database, a processing unit, and a score signal generator to provide the risk-indexing score as an output signal of the risk scoring measuring system. The processing unit comprises a driving scenario module configured for determining various driving scenarios for the vehicle by defining a set of measurable scenario characteristics, wherein a measurable scenario characteristics characterizes a vehicle variable, an environmental condition variable, a driver variable and/or an ADAS variable. Each of the various driving scenarios determined by the driving scenario module includes at least one ADAS variable. A test setting module of the processing unit is configured for determining a test setting for measuring the set of measurable scenario characteristics of each of the various driving scenarios by the driving testing system. According to the invention the test setting includes a multi-dimensional test matrix, which includes a testing protocol for each of the measurable scenario characteristics of each of the various driving scenarios. The test setting is transmitted to the driving testing system and the set of measurable scenario characteristics of each of the various driving scenarios is measured by the driving testing system. The driving testing system measures values of the measurable scenario characteristics according to the testing protocol of the multi-dimensional test matrix and provides a test result signal as a multi-dimensional test result signal including test result data for each of the measured scenario characteristics of each of the various driving scenarios. The processing unit further comprises a scoring module configured for generating the risk-indexing score by receiving the multi-dimensional test result signal from the test setting module or the driving testing system. Further, the scoring module is configured for receiving a historical data information signal from the accident database. The historical information data signal indicates a probability of occurrence of an accident and/or a damage magnitude for one or more historic driving scenarios, which at least partially comprise the measured scenario characteristics of one or more of the various driving scenarios as defined by the driving scenario module and as indicated in the multi-dimensional test result signal. The historical data provide a quantified measure of frequency of accidents and/or severity of damage associated to the various driving scenarios. That means the historical data provide a historical risk score for driving scenarios with the same or mostly the same variable values as the various driving scenarios. Further, the scoring module comprises a scoring structure with a weighting module with a weighting structure for weighting the various driving scenarios of the vehicle and/or the multi-dimensional test result data based on the historical data information signal with respect to a contribution of each of the various driving scenarios to the overall accident probability value, and an aggregator for aggregating the weighted various driving scenarios and/or their multi-dimensional test result data to define the risk-indexing score of the vehicle. The inventive system has, inter alia, the advantages that while all the prior art testing environments and associated testing organizations worldwide only rely on collisions/crash information, where the present inventive and automated system allows to digest and add on top of those also claim data sets following a unique selection process. This is technically crucial, because collisions and crashes are police reports which are often biased towards high safety accidents. Instead, the test matrix/protocol of the present inventive system allows to cover most of the accidents at different levels of severity for a given frequency. Further, it is to be highlighted that while all the other prior art systems with associated testing organizations give a pass/fail value for each test, the present inventive system count pass/fails but also (and this is crucial) give a weight to that pass/fail. The weight stems from the relative importance that that specific scenario has on the real roads (something that is monitored and extracted automatedly from the uniquely selected dataset). The present invention of an automated vehicle testing system allows to provide full vehicle performance testing, but also individual systems/software and sensors and combinations of sensors. The inventive vehicles testing system are aimed to assess not only the risk-transfer and risk impact of the performance of vehicles/software/systems but also their safety impact, where risk is defined as a physical measure defining an accident and/or vehicle failure rate within a future time window. For engineers, risk-transfer impact is technically different than safety, where both of these get important benefits from the inventive system. Finally, it is important to understand, that the inventive testing system is adaptive and the underlying technical structure is able to cover any level of automation (from level 2 to level 4). The substantial dataset of the inventive system allows to tailor the vehicle testing system to a given geography. For each given scenario, the inventive system is able to test and give a weight to the vehicle performance based on the sampling (percentile of the distribution of speeds and offsets) value that can be chosen by the user of the system. No prior art system allows such a unique system performance.

Advantageously, the various driving scenarios are chosen according to the most common accident traffic situations, preferably according to the most critical driving behaviors. Due to the multi-causal nature of accidents and a certain randomness, a plurality of driving scenarios is determined by the driving scenario module. For example the various driving scenarios include more than 10 differing driving scenarios, preferably more than 15 differing driving scenarios, and advantageously more than 20 differing driving scenarios. The selection and determination of the various driving scenarios can be based accidentology and on statistical findings thereof.

The historical information data received from the accident database provide a quantified measure of a frequency of accidents and/or severity of a damage for past real world driving situations that are comparable to the various driving scenarios determined by the driving scenario module and their measured variable values. That means driving scenarios defined by the set of measurable scenario characteristics and as more precisely defined by the multi-dimensional test result signal can be associated to real world measured accident data, that has been captured in the past for real world accidents and that comprises the same or at least very similar measured characteristics values. For the present invention, very similar values should be understood as the next best real world accident scenario describing a driving scenario having measured values closest to the values as stated in the multi-dimensional test result signal. The next best real world accident scenario is chosen in case there is no exact match of historic data for the measured values of a driving scenario as defined by the driving scenario module and analyzed by the driving testing system. The next best scenario can be described as the scenario having historic measured values that are closest to the measured values of the multi-dimensional test result signal. The historical information data may also provide accidentology insights about frequency and severity of the various driving scenarios and their relevance in a real world setting.

For example, risk scoring measuring system of the invention determines a first driving scenario defined by: (1) a first set of measurable scenario characteristics including the measurable scenario characteristics of visibility as an environmental condition variable, headlight strength as a vehicle condition variable and autonomous headlights as an ADAS variable, (2) a second set of measurable scenario characteristics including the measurable scenario characteristics of road curvature as an environmental condition variable, drowsiness as a driver variable and driver monitoring as an ADAS variable, and (3) a third set of measurable scenario characteristics including the measurable scenario characteristics of tire pressure as a vehicle variable, speed as a vehicle variable and cross traffic alert as an ADAS variable. The example driving scenarios include only three measurable scenario characteristics for the sake of simplicity of the description of the invention. Of course, real world driving scenarios mostly include more than just three characteristics. It is an advantage of the present invention that there is no limit for the number of measurable scenario characteristics for determining a driving scenario.

For the given example, the test setting module determines a test setting by defining: (1) a first testing protocol for measuring the visibility value by light scattering, the headlight strength by an illuminance meter and an area of illumination by a camera system, (2) a second testing protocol for measuring the road curvature value by GPS positioning analysis, the drowsiness value of the driver by measuring body parameters via a wrist watch and the ADAS driver monitoring value by the time period before sending a drowsiness alarm, and (3) a third testing protocol for measuring the tire pressure value using a pressure gage, a speed value using a tachometer and a cross traffic alert value using a short/medium-range radar unit. Again, the example test setting includes only three testing protocols for the sake of simplicity of the description of the invention. The number of testing protocols basically equals the number of driving scenarios to be measured. However, the test setting may include more or less testing protocols according to test availability, accuracy, and feasibility. The test profiles are summarized in the multi-dimensional test matrix. The driving testing system measures the scenario characteristics according to the testing protocols and provides measured values for each of the scenario characteristics of each of the driving scenarios, if possible. The measured values are summarized in the multi-dimensional test result signal. The scoring module request historical information data for accident situations that resulted from driving situations with the same measured values or driving situations with the closest measured values, respectively. The historical information data assign real world accident measures to the various driving scenarios determined by the driving scenario module. The scoring structure weights and aggregates the real world accident data to generate the risk indexing score.

The inventive risk scoring measuring system and method bridges the gap between existing risk assessment information for long-term established vehicle technologies and missing information for new and technically fast developing ADAS vehicles. The risk scoring measuring system and method provide the risk-transfer technology with the missing piece of information thanks to a scientific-based and technological-based methodology.

For example, the at least one ADAS variable of a driving scenario can be characterizing an ADAS functionality of the Advanced Driver Assistance System selected from a group of ADAS functionalities at least including autonomous emergency braking, parking assistance, lane keep assistance, lane change assistance, steering assistance, autonomous headlights, automatic emergency steering, cross traffic alert, adaptive cruise control, blind spot detection, crosswind stabilization, driver monitoring and pedestrian detection/avoidance, which are the most broadly used ADAS features and therefore are present in many driving scenarios. Of course other ADAS functionalities can be included in the various driving scenarios as well, for example adaptive cruise control, glare free high beam and pixel light, anti-lock braking system, automotive night vision, blind spot detection, collision avoidance, tire pressure monitoring, etc.

In one example, the driving scenario module determines the various driving scenarios according to typical driving scenarios that are covered by ADAS functionalities. These are for example short-term braking scenarios, vehicle parking scenarios, stay in lane scenarios, lane change scenarios, last minute steering scenarios, cross traffic scenarios, tailgating scenarios, blind spot scenarios, crosswind scenarios, and pedestrian avoidance scenarios. The driving scenario module may determine the set of measurable scenario characteristics of a scenario according to statistically most commonly appearing combinations of scenario characteristics. Such statistical data may for example be extracted from the accident database or from existing risk assessment databases.

After defining the set of measurable scenario characteristics, measuring the characteristics values and determining the multi-dimensional test result signal, the multi-dimensional test result data is weighted by the weighting structure for example by assigning a weighting factor according to a magnitude of the frequency measure and/or a magnitude of the damage severity measure to the quantified measure of frequency of accidents and/or severity of damage associated to the various driving scenarios. For example, the weighting factor is high for high frequencies of accidents for a driving scenario and large damages and is low for rare occasions of accidents for a driving scenario and low damage amounts. The weighting factors can be derived statistically from historic accident and damage data for specific driving scenarios as well as be based on accidentology. The data may for example be provided by the accident database.

In an example of the risk scoring measuring system, the test setting module determines the at least one testing protocol of the test setting by selecting a protocol from a group of testing protocols at least measuring the variable values of speed reduction, impact/final speed, impact position, braking distance, warning inception, ADAS feature inception, maximum braking deceleration, maximum braking time and speed range for brake activation. These variable measures provide information about the most commonly used characteristics of accident scenarios and cover the most common driving scenarios. Of course, other variables can be subject the testing protocol as well. As mentioned before, the test setting is adapted to the defined sets of measurable scenario characteristics of various driving scenarios. The test setting module may comprise a testing protocol portfolio of commonly used and/or standardized testing procedures to draw from for determining the multi-dimensional test matrix for the various driving scenarios. Testing protocols for various driving scenarios can be stored in an external database, e.g. the accident database, and the test setting module receives testing protocols for specific driving scenarios from the database.

In one embodiment of the risk scoring measuring system the driving testing system may comprise a detection system with a plurality of scenario variable detectors for surveillance and measurement of the scenario characteristics. A scenario variable detector is for example a long-range radio wave radar unit, a Lidar infrared unit, a laser vision unit, a short/medium-range radio wave radar unit, an ultrasonic unit, a geo positioning system unit and/or a camera system for measuring the scenario variable values of the driving scenarios. Advantageously the detection system comprises a plurality of scenario variable detectors that are technically specified for measuring different characteristics. As will be explained in more detail below the scenario variable detectors can be arranged on-board of the vehicle, for example as sensors on the vehicle chassis or in the vehicle interior, can be mobile detectors, for example carried by the driver, and external detector systems, for example GPS or weather monitoring stations.

In a further embodiment of the risk scoring measuring system the driving testing system comprises a telematics system for providing telematics data capturing measures of the scenario variable detectors. The telematics system may comprise a telematics circuit associated with the scenario variable detectors for transmitting measured scenario variable values. The telematics system for example comprises mobile telematics devices associated with the vehicles, one or more wireless or wired connections, and a plurality of interfaces for connection with at least one data transmission bus of the vehicle, and/or a plurality of interfaces for connection with the scenario variable detectors and the driving testing system. The telematics system may act as a wireless node within a corresponding data transmission network by means of antenna connections for providing the wireless connection.

In one example embodiment of the risk scoring measuring system and method of the invention a number of dimensions of the multi-dimensional test matrix equals a number of measurable scenario characteristics of the sets of measurable scenario characteristics of the various driving scenarios. For the above example, there are nine measurable scenario characteristics, three driving scenarios, each having three measurable scenario characteristics. Accordingly, the multi-dimensional test matrix has nine dimensions. However, depending on the number of testing protocols of a test setting the number of dimensions of the for multi-dimensional test matrix can deviate from the number of measurable scenario characteristics. The multi-dimensional test result signal usually has the same number of dimensions as the multi-dimensional test matrix. However, it can be smaller depending on the outcome of the testing or the quality of measurements.

In a further example embodiment of the risk scoring measuring system and method the testing module and/or the driving testing system comprises a simulation structure for simulating at least one driving test according to the at least one testing protocol for simulating testing of at least one measurable scenario characteristics and generating a measured value for the at least one measurable scenario characteristics for the test result signal. In fact, the driving testing system can be replaced by the simulation structure. The simulation structure represents a physical testing reality for a course of a driving scenario and a physical impact with a measurable damage to the ADAS vehicle and/or the driver of said vehicle. The simulation structure generates the vehicle course and quantifies the physical impact and the measurable damage for example by assessing given variable values of the set of measurable scenario characteristics for a driving scenario and calculating or extrapolating a physical impact and/or a damage value. Additionally, the simulation structure may include historical real world test data for the simulated driving scenario and generate the test results based on this real world accident scenario. Advantageously, the simulation structure captures and/or measures the complex interactions between a human as a driver and an ADAS vehicle. The simulation structure provides automated prediction of accident frequencies and severity in dependence of the chosen driving scenario, and the impact the safety systems can be captured/measured for both cases, an activated or deactivated ADAS.

In a still further example embodiment of the risk scoring measuring system and method a forward-looking structure anticipates at least one future version of at least one ADAS functionality of the Advanced Driver Assistance System for forecasting a frequency of accidents and/or severity of damage for a driving scenario including the at least one future version of at least one ADAS functionality. For example, the forward-looking structure anticipates a future version of a ADAS functionality of the Advanced Driver Assistance System based on extrapolation of advancement of driving assistance of previous versions of said ADAS functionality. For example, the speed of damage reduction due to past ADAS improvements may serve as an indicator for a further ADAS version. Also, the forward-looking structure may anticipate a future version based for example on disclosures of technical details of future ADAS functionality versions and/or regulatory requirement information. The forward-looking structure is for example based on a simulative process for quantifying ADAS variables and/or driving variables related to the new version of ADAS functionality. The forward-looking module for example anticipates a future version of an ADAS functionality by simulating advancement of driving assistance of previous versions of said ADAS functionality, wherein the simulation captures historic real-world data of driving scenarios including the simulated scenario characteristics. The simulation may be based on extrapolation of the real-world data into the future. The forward-looking structure allows forecasting of an accident event having a physical impact for a driving scenario including a soon to be implemented ADAS functionality in a vehicle and consider an associated safety improvement in the risk-transfer process.

The risk scoring measuring system and method of the present invention relates to the field of risk assessment and risk measuring/indexing of vehicle driving and provides an advanced tool for assessing a risk factor for a vehicle and a driver in form of Vehicle Testing As A Service (VTaas). In particular the system and the method relate to risk assessment in the rapidly developing fields of ADAS systems and of autonomous vehicle driving. The system and method are particularly realized to provide vehicle testing scores for vehicle with new ADAS functionalities as a service for risk-transfer operations and insurance organizations. The risk scoring measuring system and method are based on a physics-inspired approach accounting for varying multiple systems and multiple configurations by using a multi-dimensional test matrix. In time, ADAS features evolve by improvement (development cycles) or by newly available ADAS features providing moving boundary conditions for risk measurement that reflect the natural tendency of technology to change and improve. The inventive system and method are able to handle a large number of risk relevant driving scenario characteristics and take technological changes and improvements into account for generating a risk score reliably and accurately representing an existing and future risk-indexing score. Due to its unique structure, the risk scoring measuring system is able to provide a risk scoring measuring system which is highly consistent and adaptive. New or additional test procedures and protocols can be defined, performed, and accounted for while keeping a high level of accuracy. Thus, the scoring structure with its analytics flow is capable of accounting for multi-dimensional systems variations, which prior art methods do not provide.

It is to be noted that the scenarios and variable settings can be based on accidentology quantifying the impact of ADAS on driving behavior and accident probability. The latest insights can be easily incorporated in the risk scoring measuring method of the invention by adjusting the set of measurable scenario characteristics of the driving scenarios and the testing protocols of the multi-dimensional test matrix. In particular, the variable settings and test results can be weighted both in terms of frequency and severity compared to other cars and median of their performance.

The risk scoring measuring system and method of the invention, inter alia, have the advantages (1) that the system is able to provide risk-indexing scores as inputs for pricing to the insurance industry and key insights for Original Equipment Manufacturers (OEM); (2) that the considered ADAS functionalities can be continuously updated to follow up on new hardware and software releases/versions or newly available new ADAS features as well as related claims experience; (3) that the system is able to provide an advanced risk-indexing score which is a risk factor rooted on consistency (i.e., a score of x today will be a score of ˜x tomorrow); (4) that the driving scenarios as a basis for the risk assessment and the test setting for testing the scenarios are based on thorough accidentology. Thus, the resulting multi-dimensional test matrix reflects scenarios characteristics which are experienced in real traffic and can be measured to reflect the real world; and (5) that not only the speed reduction (i.e., Av) but also the impact/final speed, impact position, braking distance, warning inception vs. ADAS inception and other parameters are accounted for in building the risk-indexing score.

### BRIEF DESCRIPTION OF THE DRAWINGS

The present invention will be explained in more detail below relying on examples and with reference to these drawings in which:

FIG. 1a shows a diagram schematically illustrating an exemplary Advanced Driver-Assistance System (ADAS) of a vehicle, inter alia, assisting drivers in driving and parking functions.

FIG. 1b shows a diagram schematically illustrating an exemplary vehicle comprising a driving testing system, a telematics system, and an Advanced Driver-Assistance System (ADAS).

FIG. 2 shows a schematic diagram illustrating the risk scoring measuring system and method for measuring a risk-indexing score indicating an accident probability value for an occurrence of an accident event having a physical impact with a measurable damage to a vehicle provided with an Advanced Driver Assistance System (ADAS) and/or a driver of said vehicle according to one example of the present invention.

FIG. 3 shows a first schematic diagram illustrating a hierarchical structure of driving scenarios for an ADAS vehicle defined by a set of measurable scenario characteristics for the vehicle as used in one example of the present invention.

FIG. 4 shows a second schematic diagram illustrating a hierarchical structure of driving scenarios for an ADAS vehicle defined by a set of measurable scenario characteristics for the vehicle as used in one example of the present invention.

FIG. 5 shows a schematic three-dimensional diagram illustrating a set of measurable scenario characteristics comprising a vehicle variable, an environmental condition variable, a driver variable and an ADAS variable as used for the risk scoring measuring system and method of the present invention.

FIG. 6 depicts a schematic illustration showing an example test setting for measuring a set of measurable scenario characteristics for several driving scenarios, the test setting comprising several testing protocols for measuring values of the measurable scenario characteristics as used for the risk scoring measuring system and method of the present invention.

FIG. 6a shows a diagram schematically illustrating a performance for vehicle models with respect to frequency of accidents for the same driving scenarios.

FIG. 6b shows a diagram schematically illustrating a performance for vehicle models with respect to severity of damage for the same driving scenarios.

FIG. 7 shows a diagram schematically illustrating a distribution of accident frequency and damage severity for an exemplary driving scenario.

FIG. 8 shows a diagram schematically illustrating an inventive data processing from a uniquely selected dataset to automatically generated and/or simulated expert key insights.

FIG. 9 shows a diagram schematically illustrating the building blocks of the generated testing protocols. For FIGS. 8 and 9, the fact has to be stressed that while all the prior art testing environments and associated testing organizations worldwide only rely on collisions/crash information, where the present inventive and automated system allows to digest and add on top of those also claim data sets following a unique selection process. This is technically crucial, because collisions and crashes are police reports which are often biased towards high safety accidents. Instead, the test matrix/protocol of the present inventive system allows to cover most of the accidents at different levels of severity for a given frequency. Further, it is to be highlighted that while all the other prior art systems with associated testing organizations give a pass/fail value for each test, the present inventive system count pass/fails but also (and this is crucial) give a weight to that pass/fail. The weight stems from the relative importance that that specific scenario has on the real roads (something that is monitored and extracted automatedly from the uniquely selected dataset). The present invention of an automated vehicle testing system allows to provide full vehicle performance testing, but also individual systems/software and sensors and combinations of sensors. The inventive vehicles testing system are aimed to assess not only the risk-transfer and risk impact of the performance of vehicles/software/systems but also their safety impact, where risk is defined as a physical measure defining an accident and/or vehicle failure rate within a future time window. For engineers, risk-transfer impact is technically different than safety, where both of these get important benefits from the inventive system. Finally, it is important to understand, that the inventive testing system is adaptive and the underlying technical structure is able to cover any level of automation (from level 2 to level 4). The substantial dataset of the inventive system allows to tailor the vehicle testing system to a given geography. For each given scenario, the inventive system is able to test and give a weight to the vehicle performance based on the sampling (percentile of the distribution of speeds and offsets) value that can be chosen by the user of the system. No prior art system allows such a unique system performance.

### DETAILED DESCRIPTION OF THE PREFERRED EMBODIMENTS

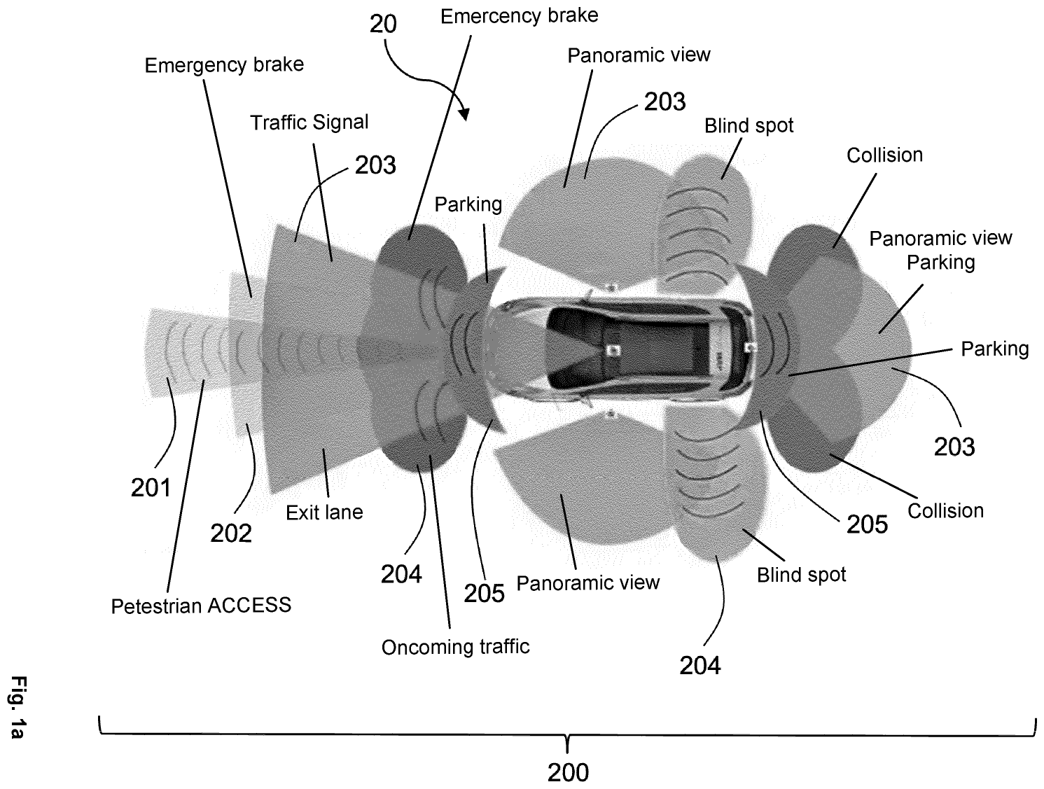

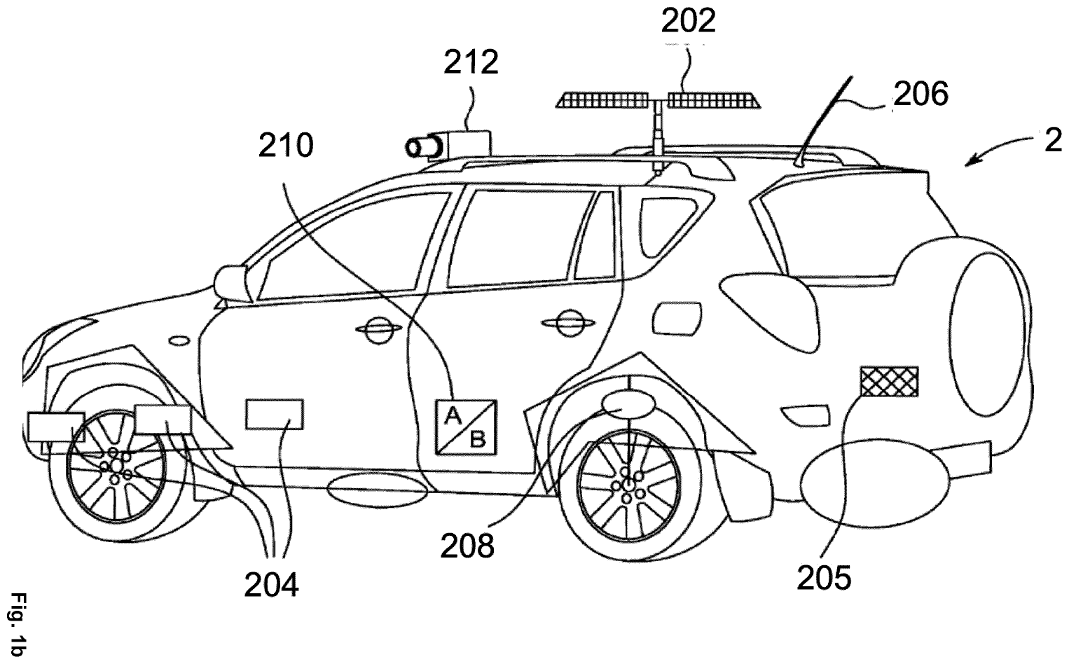

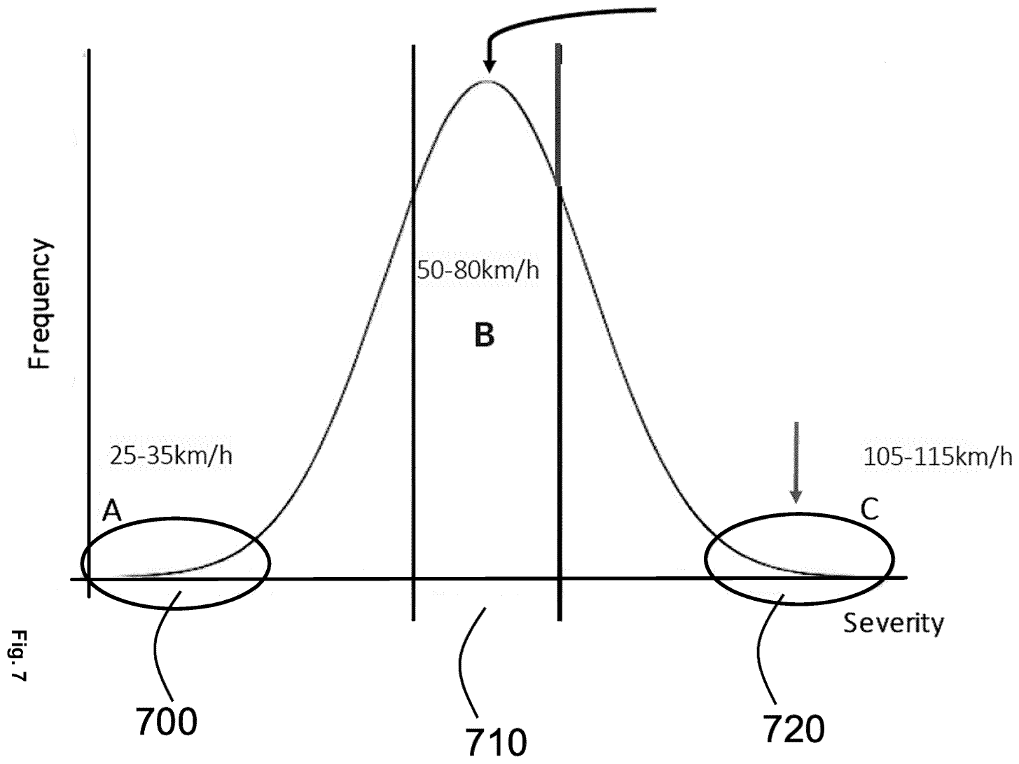

FIGS. 1 to 9 schematically illustrate components and modules of an electronic risk scoring system 1 and processes of an associated risk scoring method indicating an accident probability value, and a risk value, respectively, for an occurrence of an accident event having a physical impact with a measurable damage to a vehicle 2 provided with an Advanced Driver Assistance System (ADAS) (20) and/or to a driver of said vehicle 2.

The present invention provides an electronic risk scoring method and system 1 for measuring a risk-indexing score indicating an accident probability value for a vehicle 2 provided with at least one ADAS functionality 200. As summarized in FIG. 1 an ADAS vehicle 1 can comprise a plurality of ADAS functionalities 200 provided by various technological surveillance and detection means comprising cameras, detectors, recording devices, etc., For example, the ADAS vehicle 2 comprises a long-range radio wave radar unit 201, which surveys for example a range of about 250 m ahead of the vehicle. A Lidar infrared or laser vision unit 202 is able to monitor a range of about 150 m from the vehicle. A camera system 203 comprising several cameras aiming in different directions around the vehicle surveying a radius of up to 100 m around the vehicle. A short/medium-range radio wave radar unit 204 observes an area of up to 30 m from the vehicle, and an ultrasonic unit 205 reaches out up to 5 m.

Additional monitoring or measuring devices might be installed to detect for example driver characteristics, vehicle characteristics and environmental characteristics. For example, health parameters of the driver can be surveilled by wrist watches, vehicle positioning could be detected by GPS devices 206 and environmental conditions could be monitored by thermometers, barometers, etc. The various technological surveillance and detection means and the additional monitoring and measuring devices together build a scenario detection system 220 for the driving testing system 3 of the risk scoring measuring system 1, as will be explained in more detail below.

The technological surveillance and detection means and devices enable numerous ADAS functionalities 200, and enable constant improvement of these functions within the vehicle. The vehicle 2 comprises a plurality of electronic processing and controller units and circuitries to collect and process monitoring and measuring data from the surveillance and detection means 201-205 and other devices, and to control the ADAS functionalities 200 accordingly. As mentioned there are a plurality of ADAS functionalities 200 that are based on observing the vehicle behavior, the driving behavior, the environmental conditions, and the driver. A few examples of ADAS functionalities are the following ADAS features.

Automatic emergency braking (AEB) systems use sensors and computer processing to detect when the vehicle could collide with an object in its path and applies the brakes automatically attempting to mitigate or avoid the collision, even if the driver takes no action. AEB systems use for example the Lidar infrared or laser vision unit 201 and/or the short/medium-range radio wave radar unit 204, work in different driving conditions (e.g. highways, urban) and act on the vehicle in different ways (e.g. only slow the vehicle or bring it to a complete stop). Automated lane keeping assistance (LKA) systems keep the vehicle within its lane by controlling the lateral and longitudinal movements of the vehicle for extended periods without the need for further driver input. The LKA system uses for example long-range radio wave radar unit 201 and/or camera systems 203 The driver activates and deactivates the LKA system manually. An automatic emergency steering (AES) system detects when the vehicle could collide with an object in its path and applies steering inputs automatically attempting to mitigate or avoid the collision, even if the driver takes no action. AES systems can act on the vehicle in different ways depending on the driving situation. AES systems can consider the vehicle's surroundings and other objects and their trajectories to determine a predicted minimal risk steering trajectory. They are based for example on camera systems 203 and Lidar infrared systems 202. An automatically commanded steering function is based on an electronic control system where actuation of the steering system can result from automatic evaluation of signals initiated on-board the vehicle, possibly in conjunction with passive infrastructure features, to generate continuous control action in order to assist the driver. A cross traffic alert (CTA) system detects hazards approaching from the side of the vehicle and warns the driver of a potential collision. Front cross traffic alert systems relate to hazards approaching from the side as the vehicle pulls forward into moving traffic. Rear cross traffic alert systems relate to hazards approaching from the side as the ego vehicle reverses into moving traffic. An intelligent speed adaption (ISA) system supports drivers in complying with legally enforced speed limits. ISA systems can use satellite-based positioning and track the position against a database of speed limits and/or cameras to detect speed limits shown on road signs. Speed limits may also be broadcast from infrastructure to vehicles to communicate relevant speed limits to the ISA system. Some systems provide a driver only with warnings of excessive speed while others actively moderate vehicle speed to comply with limits. An automatically adaptive headlight system automatically turns headlights on and off and changes headlight position based on steering wheel movement and vehicle speed. Headlights pivot from side to side to improve visibility on dark, curved roads. More advanced systems detect the lights of other vehicles and redirects the vehicle's lights away to prevent other road users from being temporarily blinded. An automatic parking system informs a driver of unseen areas so the driver knows when to turn the steering wheel and stop. For example, the automatic parking system uses ultrasonic units 205 and short/medium-range radio wave radar units 204. Additionally, they can be able to measure available spaces on the roadside and detect suitable parking spaces. The driver will receive an alert, and the parking system can take over the accelerator, brakes, and the steering of the vehicle for autonomous parking. A driver monitoring system warns drivers of sleepiness or other road distractions. There are several ways to determine whether a driver's attention is decreasing. For example, sensors analyze the movement of the driver's head and heart rate to determine whether they indicate drowsiness. The system may issue driver alerts similar to warning signals for lane detection. Also, camera sensors may be used to analyze whether the driver's eyes are on the road or drifting. In advanced system versions, the ADAS will take the extreme measure of stopping the vehicle completely.

The above list is not conclusive and there are many more ADAS features currently available. Additionally, ADAS functionalities are constantly improving and additional features are developed. The increasing amount of automotive electronic hardware and software, advanced detection and surveillance technologies, and growing databases allow for rapid changes in today's automobile design. The trend is shifting from distributed ADAS electronic controller units to a more integrated ADAS domain controller with centralized units. Currently available technologies allow for partial driving automation, where the vehicle can control both steering and accelerating/decelerating but falls short of self-driving because a human sits in the driver's seat and can take control of the car at any time and turn on/off the ADAS functionalities respectively. In a next technology step, fully autonomous driving will be possible and connected vehicle technology will improve information and data accessibility.

Some ADAS functionalities are already or will soon become mandatory for new vehicles. For example, in Spain from July 2022, important systems such as autonomous braking, lane keeping systems, intelligent speed assistance, and tire pressure monitoring in trucks and vans will be mandatory for new vehicles. Other ADAS functionalities are optional and depend on the preference of the driver to install the features in the car or simply to turn them on while driving. As a consequence, for new and existing vehicles it is not clear which accident avoidance features of an ADAS are in place to actually prevent an accident. Consequently, it is difficult to determine a risk score for vehicles using ADAS functionalities, there are no standardized risk measurements in place and existing risk scoring methods do not reflect the probability of engaging in an accident in a realistic manner.

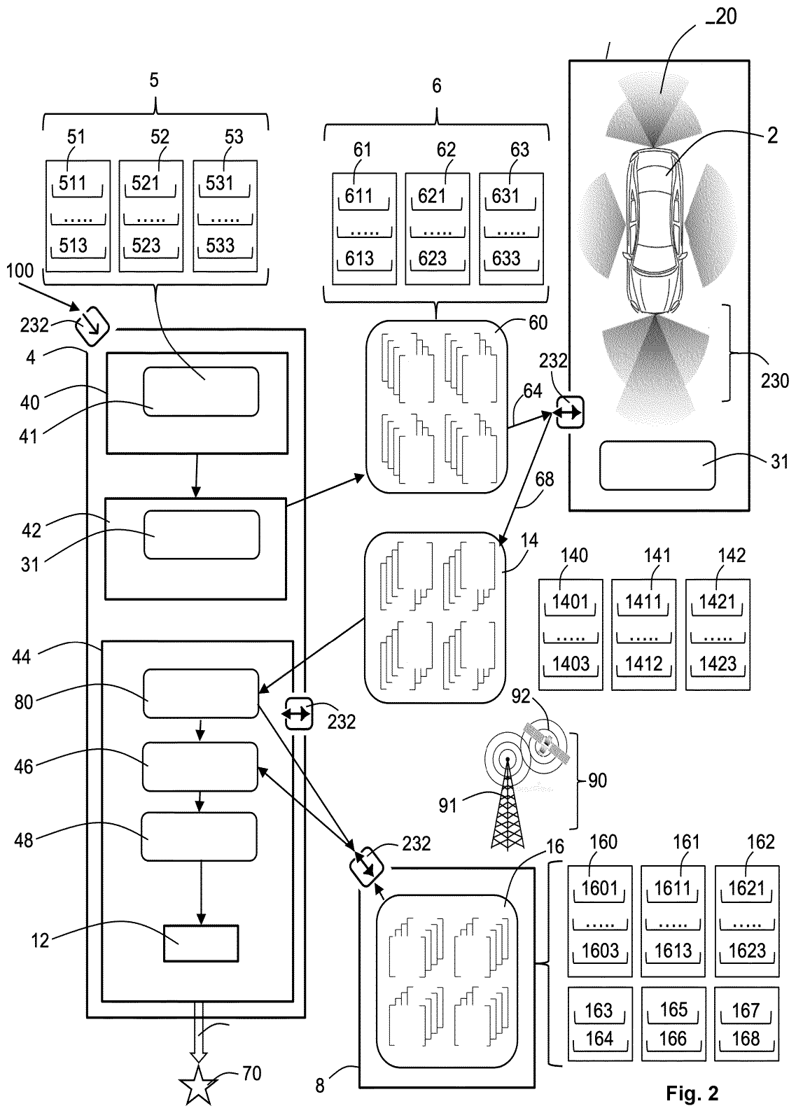

The present invention overcomes these deficiencies by providing an electronic risk scoring system and method that improves accuracy and accessibility of measuring a risk-indexing score indicating an accident probability value for an occurrence of an accident event having a physical impact with a measurable damage to a vehicle provided with an Advanced Driver Assistance System (ADAS) and/or a driver of said vehicle. The inventive method provides the risk-indexing score in form of Vehicle Testing As A Service (VTaas). As illustrated in FIG. 2, the risk scoring measuring system 1 according to the invention at least comprises a driving testing system 3, an accident database 8, a processing unit 4, at least one data signal transmitter/receiver and a score signal generator 12. The driving testing system 3 may include the above mentioned surveillance and measuring means and devices, and may include additional testing systems as used in conventional vehicle driving tests or performance tests.

The processing unit 4 comprises at least a driving scenario module 40, a test setting module 42 and a risk scoring module 44. The driving scenario module 40 is configured for determining various driving scenarios 5 for the vehicle 2 by defining a set of measurable scenario characteristics 50, 51, 52, . . . for each driving scenario. A measurable scenario characteristics characterizes a vehicle variable, an environmental condition variable, a driver variable and/or an ADAS variable. A variable can be determined by a measure indicating a variable value, for example determined by measuring said variable using any of the above mentioned surveillance or measuring means or devices that are part of the driving testing system 3. The various driving scenarios 5 each include at least one ADAS variable of the ADAS vehicle 2, preferably they include all ADAS variables of ADAS functionalities 200 available in the ADAS vehicle 2 that is to be tested. The test setting module 42 is configured for determining a test setting 6 for measuring the set of measurable scenario characteristics 50, 51, 52, . . . of each of the various driving scenarios 5 by the driving testing system 3. The test setting 6 is defined by testing protocols 61, 62, 63, . . . transmitted to the driving testing system 3, which then provides measured values of the measurable scenario characteristics according to the measuring initiated by the testing protocols as a test result signal. According to the present invention a test setting 6 defined by the test setting module 42 includes a multi-dimensional test matrix 60, which includes the testing protocol 61, 62, 63, . . . for each of the sets of measurable scenario characteristics 50, 51, 52, . . . of the various driving scenarios 5. Accordingly, test result signal 14 is a multi-dimensional test result signal 14 including test result data for each of the measured scenario characteristics of each of the various driving scenarios 50, 51, 52, . . . as measured according to the testing protocols 61, 62, 63, . . . .

For the testing by the present testing apparatus and inventive system, a vision system can e.g. be used to simulate a driver's visual feedback. Vehicle position and orientation can be measured and compared with a desired position or trajectory. To provide high contrast measures, small LED lights can e.g. be positioned at the four corners of the vehicle. Image capture and processing can e.g. be performed by a digital camera. The camera can e.g. generate the position and orientation of the car within a periodic time interval, as e.g. approximately every 180 ms, and the data can be sent to a controller via data-transmission communication. The steering and throttle inputs on the scale vehicle can e.g. accept standard servo inputs. The communication between the real-time controller of the system and the vehicle can e.g. be achieved using a controller board from the prior art. Such boards are capable of producing pulse-width modulated signals to drive the steering servo and the throttle controller. Comparison of the scale-modelling structure and the full-size vehicles require that the two vehicles are dynamically similar. Dynamic similitude can be shown using e.g. the Buckingham-Pi Theorem by replacing the dimensional physical parameters with dimensionless products and rations. Such dimensionless groups, e.g. Pi groups, can be formed from the ratios of physical parameters. Two systems are dynamically similar, if the corresponding Piu groups are equal. The difference between the Pi groups of the scale-modelling structure and the full-size vehicles can bd resolved by modifying the scale-modelling structure of the vehicle. After measuring the parameters of the scale-modelling structure of the vehicle, the Pi group is generated by the system. In order to achieve dynamic similitude, the Pi group of the scale-modelling structure of the vehicle can e.g. be compared and matched by the system to the Pi group of a number of full-size vehicles of various size, types, and manufacturers. The built the scale-modelling structure of the vehicle, the system can further e.g. rely at least (A) on the determination of the vehicle's center of gravity, where for most full-sized vehicles, the center of gravity is closer to the front axle that the rear axle due to the placement of the engine; (B) further, on the determination of the vehicle's moment of inertia, where the moment of inertia about the z-axis of the scale-modelling structure of the vehicle can e.g. be found by approximating the vehicle's shape and weight distribution; and (C) further on the determination of the tires and assigned parameter values, where along with the vehicle parameters, the tire parameters can e.g. be investigated in order to match the measured Pi groups and produce dynamic similitude automatically by the system between the scale-modelling structure of the vehicle and the full-size vehicle. Finally, the vehicle control system can e.g. comprise a longitudinal and lateral control system. The technical objective of these control system s is to regulate the position of the scale-modelling structure of the vehicle with respect to a treadmill. The longitudinal and lateral control systems can e.g. use the information of the vision system to ensure that the vehicle remains in the center of the treadmill.

In the example risk scoring measuring system 1 illustrated in FIG. 2 the driving scenario module comprises a forward-looking structure 41 to anticipate at least one future version of at least one ADAS functionality of the Advanced Driver Assistance System 20 for forecasting a frequency of accidents and/or severity of damage for a driving scenario including the at least one future version of at least one ADAS functionality. The forward-looking structure 41 is used to automatically predict a change in future driving behavior due to advanced ADAS functionalities available to vehicle 2, which influences the accident probability value of the vehicle. Taking future versions of ADAS functionalities 200 into account improves the accuracy of the risk-indexing score 70. In the illustrated example, the driving testing system 3 and the test setting module 42 comprise a simulation structure 31 for simulating at least one driving test according to the at least one testing protocol for simulating testing of at least one measurable scenario characteristics and generating a measured value for the at least one measurable scenario characteristics for the test result signal. It is sufficient to have one of the simulation structures, however it advantageous to have a back-up and/or complementary simulation structures. As mentioned above the simulation structure 31 can be based on statistical methods, extrapolation and/or accidentology methods for simulating a real world testing approach and generating a result value that reflect a contribution of the scenario characteristics to the accident probability. The simulation structure 31 allows for filling test result gaps for example in case of missing reliable test procedures for scenario characteristics, poor historic data quality, high costs for testing of scenario characteristics. It is emphasized that all variable values of the set of measurable scenario characteristics can be captured by the simulation structure 31.

The scoring module 44 is configured for generating a risk-indexing score 70 by receiving the multi-dimensional test result signal 14 from the test setting module 42 or the driving testing system 3, respectively, and receiving a historical information data signal 16 from the accident database 3. The historical information data signal 16 indicates a probability of occurrence of an accident and/or a damage magnitude for a driving scenario at least partially comprising the measured values for the scenario characteristics preferably for each of the various driving scenarios 5 as indicated in the multi-dimensional test result signal 14. The historical information data provide a quantified measure of a frequency of accidents and/or severity of damage associated to each of the various driving scenarios 5 for example based on previous real world analytics or accidentology. That means a driving scenario defined by the measured values as summarized in the multi-dimensional test result signal 14 is associated to real world measured accident data, that has been captured in the past for real world accidents and which comprise the same or at least very similar measured characteristics values. For the present invention, very similar values should be understood as the next best real world accident scenario describing a driving scenario having measured values closest to the values as stated in the multi-dimensional test result signal 14 as explained above. The next best real world accident scenario is chosen in case there is no exact match of historic data for the measured values of a driving scenario as defined by the driving scenario module 40 and analyzed by the driving testing system 3. The next best scenario can be described as the scenario having historic measured values that are closest to the measured values of the multi-dimensional test result signal 14 and/or as a scenario established by accidentology research.

The scoring module 44 of the processing unit 4 receives the multi-dimensional test result signal 14 and the historical information data signal 16. The scoring module 44 comprises a scoring structure with a weighting structure 46 configured for weighting the multi-dimensional test result data 16 based on the historic values provided by the historical information data signal 16 with respect to a contribution of each of the various driving scenarios and scenario characteristics to the accident probability value. In absence of exact historic value data, a next best scenario is extracted based on the closest historic information data, preferably based on accidentology. A weighting factor is defined and applied to the variable values supplied by the multi-dimensional test result signal. The scoring module 44 further comprises an aggregating structure 48 configured for aggregating the weighted multi-dimensional test result data of each of the various driving scenarios 5 to define the overall risk-indexing score 70. The score signal generator 12 generates an output signal for the risk indexing score 70 indicating the accident probability value for the ADAS vehicle 2. The risk-indexing score 70 can serve as a quantitative risk transfer score and as the basis for calculating an insurance premium, defining policies and regulations regarding advanced driving assistance systems, for further developing ADAS functionalities and other objects.

The driving testing system 3 of the example risk scoring measuring system 1 as shown in FIGS. 1a and 1b comprises the scenario detection system 220 with a plurality of scenario variable detectors as mentioned before and a telematics system 230 for collecting and communicating measures of the scenario variable detectors of the detection system 220 as telematics data to the processing unit 4. The telematics system 230 comprises a telematics circuit associated with the scenario variable detectors for transmitting measured scenario variables to the processing unit 4. The processing unit 4 comprises a data administration structure 80 receiving the data of the measured scenario variables from the telematics system 230 and structuring the data as the multi-dimensional test result signal 14 for further processing in the weighting structure 46. The telematics circuit is part of the driving testing system 3 and dynamically receives measuring data of the measured values from the scenario detection system 220 and communicates the data to the processing unit 4.

The scenario detection system 220 represents a collection of various surveillance and detection means and telematics components used to monitor driving behavior, speed patterns, distance traveled, driver condition and driving environment to assess the set of measurable scenario characteristics of the various driving scenarios 5. Herein, the term “telematics” is used to describe vehicle onboard communication services and applications that communicate with one another via receivers and other telematics devices. For the purposes of the present disclosure, the telematics data captured may include, e.g., but not limited to, location, speed, idling time, harsh acceleration or braking, fuel consumption, vehicle faults, and more. Further, the telematics system 230 may include mobile telematics devices adapted to send, receive, and store information via telecommunication devices. The mobile telematics devices are configured to store and/or send measurement data associated with a condition of the vehicle, the driver, and the environment. The mobile telematics devices may be in the form of plug-in or integrated vehicle informatics and telecommunication devices capable of remote communication. For example, the mobile telematics device may be attached to an on-board diagnostics system of the vehicle to receive data associated with the vehicle from a vehicle bus. In another example, the mobile telematics devices may be integrated with the vehicle. For example, the mobile telematics device may be a Global Positioning System (GPS) technology integrated with computers and mobile communications technology present in automotive navigation and internal network systems.

FIGS. 1a and 1b illustrate the Automated Driving Assistance System 20, the scenario detection system 220 and various scenario variable detectors for the vehicle 2. The scenario detection system 220 may be disposed in signal communication with the telematics system 230. The scenario detection system 220 may generally be defined to include all sensing means that may be part of the vehicle. The scenario detection system 220 may include proprioceptive sensors for sensing operating parameters of the motor vehicle and/or exteroceptive sensors for sensing environmental parameters during operation of the motor vehicle, as for example the above mentioned surveillance and measuring means and devices. The exteroceptive sensors or measuring devices may, for example, include the long-range radio wave radar unit 201 and the short/medium-range radio wave radar unit 204 for monitoring surrounding of the vehicle 2 and/or the Lidar infrared or laser vision unit 202 for monitoring surrounding of the vehicle 2 and/or global positioning systems or vehicle tracking devices for measuring positioning parameters of the vehicle 2 and/or odometrical devices for complementing and improving the positioning characteristics values measured by global positioning systems or vehicle tracking devices and/or the camera system 203 comprising for example computer vision devices or video cameras for monitoring the surrounding of the vehicle 2 and/or the ultrasonic unit 205 for measuring the position of objects close to the vehicle 2. The proprioceptive sensors or measuring devices for sensing operating characteristics of the vehicles 2 may include motor speed measuring device e.g. measuring revolutions per minute (rpm), i.e. the number of turns per minute and/or wheel load and/or heading and/or battery status and/or speedometer of the vehicles 2, and the like. The driving detection system 220 may also include further sensors, which may be part of the telematics system 230. Such further sensors may include, but not limited to, a GPS module 206 (Global Positioning System), odometrical units 208 for complementing and improving the positioning parameters measured by global positioning systems, proprioceptive sensors 210, vehicle tracking devices and/or computer vision devices 212 and/or geological compass module based on a 3-axis teslameter and a 3-axis accelerometer, and/or gyrosensor or gyrometer, and/or a MEMS accelerometer sensor comprising a consisting of a cantilever beam with the seismic mass as a proof mass measuring the proper or g-force acceleration, and/or a MEMS magnetometer or a magneto-resistive permalloy sensor or another three-axis magnetometers. An on-board diagnostic system is a computer system, generally, inside the vehicle that tracks and regulates a vehicle's performance. The scenario detection system 220 may include an on-board diagnostic system and an in-vehicle interactive network system for collecting and communicating data and information from the driving testing system 210.

The telematics system 230 associated with the driving detection system 220 can e.g. comprise one or more wireless or wired connections, and a plurality of interfaces 1041 for connection with at least one of a vehicle's data transmission bus, and/or a plurality of interfaces 232 for connection with the surveillance and measuring means and devices and the processing unit 4. The one or more wireless connections or wired connections of the telematics system 230 may include Bluetooth (IEEE 802.15.1) or Bluetooth LE (Low Energy) as wireless connection for exchanging data using short-wavelength UHF (Ultra high frequency) radio waves in the ISM (industrial, scientific and medical) radio band from 2.4 to 2.485 GHz by building a personal area network (PAN) with on-board Bluetooth capabilities and/or 3G and/or 4G and/or GPS and/or Bluetooth LE (Low Energy) and/or BT based on Wi-Fi 802.11 standard, and/or a contactless or contact smart card, and/or a SD card (Secure Digital Memory Card) or another interchangeable non-volatile memory card. The data transmission may take place using standard wired network, including a fiber or other optical network, a cable network; or alternatively using wireless networks such as wireless local area networks (WLANs) implementing Wi-Fi standards, Bluetooth standards, Zigbee standards, or any combination thereof. In particular, the telematics system 230 may provide mobile telecommunication networks as, for example, 3G, 4G, 5G LTE (Long-Term Evolution) networks or mobile WiMAX or other GSM/EDGE and UMTS/HSPA based network technologies, etc.

The risk scoring measuring system 1 shown in FIG. 2 comprises a data transmission network 90 or data transmission line, e.g. comprising a cellular mobile network 91 and/or a satellite transmission line 92, for transmitting data between the processing unit 40, the driving testing system 3 and the accident database 8. The ADAS 20, the scenario variable detectors of the detection system 220 and the telematics system 230 can for example be connected to the processing unit 40 by the data transmission network 90. The accident database 8 can for example be hosted in a cloud storage space and provided via the data transmission network 90. Also, the risk-indexing scores 70 measured by the risk scoring measuring system 1 can be hosted in a cloud storage space and transmitted as a service to entities and organizations interested in using the risk-indexing scores 70.

An exemplary risk scoring measurement according to the invention is described using the risk scoring measuring system 1 as illustrated in FIG. 2. The processing unit 4 of the system 1 receives an inquiry of a user for measuring a risk-indexing score indicating an accident probability value for an occurrence of an accident event for the vehicle 2. The inquiry may for example be placed using an online user application provided as an online platform with a user interface to the risk scoring measuring system 1. The inquiry provides inquiry input data 100 about the driver and the vehicle to the processing unit 4. The inquiry input data 100 for example provides information about the age, sex, marital status, employment, driving history, etc. of the driver and about the year, make, model, engine characteristics, ADAS functionalities, etc. of the vehicle 2, as far as available for the inquiry.

Based on the inquiry input data 100, the driving scenario unit 40 determines various driving scenarios 5 for the vehicle 2. In the shown example three driving scenarios 5 are determined: (1) An emergency braking driving scenario is defined by the first set of measurable scenario characteristics 51 including a driver attention variable 511, a distance to front obstacle variable 512 and an ADAS maximum braking deceleration variable 513. (2) A blind spot driving scenario is defined by the second set of measurable scenario characteristics 52 including a vicinity movement variable 521, a speed of vicinity movement variable 522 and an ADAS movement warning inception variable 523. (3) A heavy traffic driving scenario is defined by the third set of measurable scenario characteristics 53 including a vehicle speed variable 531, a traffic signage information variable 532 and an ADAS cruise control speed reduction variable 533. Each of the sets of measurable scenario characteristics includes an ADAS variable. For the emergency braking driving scenario the forward-looking structure 41 of the driving scenario module 40 anticipates a future version of the ADAS functionality of autonomous emergency braking, since this a rapidly developing field of ADAS functionalities and the vehicle 2 is most likely updated with such a future version with a very short timeline of only a few month. Therefore, the ADAS maximum braking deceleration variable 513 is based on a future version of the ADAS functionality of autonomous emergency braking. As mentioned above, the risk scoring measuring system 1 is configured for determining more than three driving scenarios. The number of scenarios may depend on a specific inquiry case and can vary from case to case.

Based on the sets of measurable scenario characteristics 51, 52 and 53 the test setting module 42 determines a test setting 6 for measuring the variables of the sets of measurable scenario characteristics of each of the driving scenarios 5. The test setting 6 defines a testing protocol preferably for testing each of the measurable scenario characteristics of the sets of measurable scenario characteristics 51, 52 and 53: (1) an emergency braking testing protocol 61 for testing the set of measurable scenario characteristics 51 defines driver attention testing 611 e.g. using in-vehicle camera monitoring of drivers eye activity, distance to obstacle testing 612 e.g. using the Lidar infrared or laser vision unit 202, and ADAS maximum braking deceleration testing 613 e.g. using a simulation of a potential maximum braking deceleration based on the technical specification of the future version of the of the ADAS functionality of autonomous emergency braking. (2) a blind spot testing protocol 62 for testing the set of measurable scenario characteristics 52 defines vicinity movement testing 621 e.g. using short/medium-range radio wave radar monitoring of vehicle vicinity, speed of vicinity movement testing 622 e.g. using panoramic view cameras, and ADAS movement warning indication testing 623 e.g. using time measurement since first indication of movement. (3) a heavy traffic testing protocol 63 for testing the set of measurable scenario characteristics 53 defines vehicle speed testing 631 e.g. using the vehicle's tachometer, traffic signage recognition testing 632 e.g. using front view cameras, and ADAS cruise control speed reduction testing 633 e.g. using adapted speed measuring and adaption start indication. The testing protocols combined are defined by the multi-dimensional test matrix 60. The multi-dimensional test matrix 60 therefore includes the testing protocols for each of the measurable scenario variables of the driving scenarios. It is to be noted, that a testing protocol may indicate not to test one or more of measurable characteristics of a driving scenarios, for example due to a lack of reliable testing methods or a lack of information required for testing.

The test setting 6 is transmitted as a test setting input signal 64 to the driving testing system 3, which measures the variable values for each of the sets of measurable scenario characteristics 51, 52 and 53 of the driving scenarios 5 according to the multi-dimensional test matrix 60 of the test setting 6. Alternatively, instead of actually testing the driving behavior of the vehicle and the driver, the simulation structure 31 of the test setting module 42, may generate test results for the variables of the measurable scenario characteristics, as discussed above. The driving testing system 3 provides an output signal 68, that includes test result data for each of the measured scenario characteristics of the driving scenarios 5. For the shown example, the testing system output data 68 provides: (1) a set of emergency braking variable values 140 indicating driver attention value 1401, a braking distance to obstacle value 1402, and a potential maximum braking deceleration value 1403 based on the simulation of the future version of the ADAS functionality of autonomous emergency braking. (2) a set of blind spot variable values 141 indicating a vicinity movement value 1411, a speed of vicinity movement value 1412, and an ADAS movement warning indication value 1413. (3) a set of heavy traffic variable values 142 indicating a vehicle speed value 1421, a traffic signage recognition value 1422, and a speed reduction value 1423. The testing system output data signal 68 is transmitted to the processing unit 4, particularly to the data administration structure 80, which structures the value testing data in a suitable format defining the multi-dimensional test result signal 14 for further processing by the weighting structure 46.

The data administration structure 80 sends the multi-dimensional test result signal 14 in form of an input signal 69 to the accident database 8 and requests information data of historic driving scenarios comprising equal or closest values as the values measured for the scenario characteristics of the three driving scenarios 5. The accident database 8 provides the historical information data signal 16, which indicates a probability of occurrence of an accident and/or a damage magnitude for historic driving scenarios, which at least partially comprise the measured scenario characteristics of the driving scenarios 5 as indicated in the multi-dimensional test result signal 14. That means the accident database provides historical risk scores of historic driving scenarios having the same or close to the same variable values as the tested driving scenarios 5. The historical data provide a quantified measure of frequency of accidents and/or severity of damage associated to the measured values of the three driving scenarios 5. The historic data request may include boundaries which define a ranges of interest for each of the scenario characteristics. The interest range may for example be defined as +/−5% deviation of the measured scenario variable value, preferably +/−2% deviation. Thus, the historic information about scenario characteristics is in a range of +/−5% or +/−2%, respectively, of the measured values. For driving scenarios with variable values in this range, the accident database provides historical data about quantified measures of frequency of accidents and/or severity of damage associated to such driving scenario.

The scoring module 44, particularly the weighting structure 46, receives the historical information data signal 16 comprising the historical data of driving scenarios that in the past triggered or nearly triggered an accident event having a physical impact with a measurable damage. It is noted that the historic information data may derive from vehicles with or without ADAS as long as other driving scenario variable values are equal or at least similar to the tested variable values.

For the present example, the historical information data signal 16 provides: (1) a quantified measure 163 of frequency of historic emergency braking accidents for at least one historic emergency braking driving scenario comprising historical scenario variable values equal or closest to the set of emergency braking variable values 140, and a quantified measures 164 of severity of historic emergency braking damage associated to the emergency braking accidents. Additionally, the historical information data may comprise a set of historic emergency braking values 160 for the historic emergency braking driving scenario indicating a historic driver attention value 1601, a historic distance to obstacle value 1602, and a historic maximum braking deceleration value 1603. (2) a quantified measure 165 of frequency of historic blind spot accidents for at least one historic blind spot driving scenario comprising historical scenario variable values equal or closest to the set of blind spot variable values 141, and a quantified measures 166 of severity of historic blind spot damage associated to the blind spot accidents. Additionally, the historical information data may comprise a set of historic blind spot variable values 161 for historic driving scenarios equal or closest to the measured set of blind spot variable values 141 indicating a historic vicinity movement value 1611, a historic speed of vicinity movement value 1612, and a historic movement warning indication value 1613. (3) a quantified measure 167 of frequency of historic heavy traffic accidents for at least one historic heavy traffic driving scenario comprising historical scenario variable values equal or closest to the set of heavy traffic variable values 142, and a quantified measures 168 of severity of historic heavy traffic damage associated to the heavy traffic accidents. Additionally, the historical information data may comprise a set of historic heavy traffic variable values 162 for historic driving scenarios equal or closest to the measured set of heavy traffic variable values 142 indicating a historic vehicle speed value 1621, if available, a historic traffic signage recognition value 1622, and a historic speed reduction value 1623.

In a next step, the weighting structure 46 is weighting the multi-dimensional test result data 60 based on the information provided by the historical information data signal 16 with respect to a contribution of each of the driving scenarios 5 to the accident probability value of the vehicle. For the present example, an accident risk associated to the frequency and severity of historic emergency braking accidents measures may be allocated a higher weighting factor than an accident risk associated to the frequency and severity of historic blind spot accidents measures, for example because the historic scenario variable values of the emergency braking are identical to the measured scenario variable values for the emergency braking driving scenario, while the historic scenario variable values of the blind spot deviate by 5% relative to the measured scenario variable values for the blind spot driving scenarios. The weighting factor for the emergency braking scenario may also be defined to be higher because the magnitude of the damage caused by emergency braking accident is higher than the damage magnitude of blind spot scenarios by a quantified amount. As mentioned above, the weighting factors can be assessed by common statistical methods by analyzing the historic scenario information provided by the accident data base 8. Next, the aggregator 48 automatically aggregates the weighted multi-dimensional test result data of the driving scenarios 5 to define the aggregated risk-indexing score 70 for the vehicle 2. The aggregated risk-indexing score 70 can be provided to the user as a response to the original inquiry. For example, the risk-indexing score 70 can be accessed online via the online user application platform.

The risk scoring measuring system and method for measuring a risk-indexing score 70 indicating an accident probability value according to the invention has the advantage that the generation of the risk-indexing score 70 is not limited to human expert opinions or simple statistical evaluations based on risk class factors like age, gender, marital status, place of residence, number of driving years, driving history or credit history of the driver or vehicle characteristics like model, year, engine characteristics and vehicle type. The system and method of the present invention is capable of including a large number of measured scenario characteristics and includes vehicle variables, environmental condition variables, driver variables and ADAS variables. Furthermore, the system and method of the present invention is able to quantify risk-indexing scores for vehicles with soon to come ADAS functionalities by including future versions of the ADAS functionalities.

FIG. 3 shows a schematic diagram illustrating a hierarchical structure of driving scenarios 5 for an ADAS vehicle 2 defined by a set of measurable scenario characteristics for the vehicle. In a definition step 300 for determining the various driving scenarios and the test setting, the ADAS functionalities as well as the other features and systems related to driving scenarios that are subject to be tested are defined and sets of measurable scenario characteristics for the driving scenarios are determined. The determined driving scenarios are distinguished by the measurable scenario characteristics characterizing specific vehicle variables, environmental condition variables, driver variables and ADAS variables. Differentiation in just one variable can result in a differing driving scenario. The various driving scenarios have a high granularity. In a risk transfer analysis step 310 the contribution of the scenario characteristics variables of the driving scenarios is analyzed, for example by comparison with historical accident information, and a probability distribution of a relevance for risk scoring is assessed for each of the driving scenarios. In a subgroup step 320 the driving scenarios comprising a significant relevance for a risk scoring are summarized to a scenario subgroup, while insignificant scenarios are discarded. In a subgroup analysis step 330 the contribution of a driving scenario within the subgroup to a risk score is analyzed, for example by assessing a probability of occurrence of an accident for the scenario or by assessing a damage magnitude. A weight factor is defined for the subgroups according to the identified risk contribution of scenarios. In a group step 340 the driving scenarios subgroups comprising a significant weight factor are summarized to a scenario group, while insignificant subgroups are discarded. In a group analysis step 350 the contribution of the scenario group within an overall risk-indexing score is analyzed, for example by assessing the frequency and severity of accidents for the scenarios. The groups are assigned a group weight factor for example based on historical insurance data. In a score indexing step 360, the scenario groups are aggregated according to their group weight factor and global overall risk-indexing score is generated. As a result, the assessment of the risk-indexing score starts of with wide-ranging assessment of a plurality of driving scenarios, while over the course of the assessment scenarios are extracted according to their contribution to the risk-indexing score. Low contribution scenarios are discarded while scenarios with significant risk contributions are further assessed. The analytics flow starts with a high granularity of scenario variations and evolves towards a low granularity. Additional tests could be defined, performed, and accounted for while keeping a high level of accuracy. For example all driving scenarios referring to a car to car rear braking scenario are summarized to a subgroup. The subgroup scenarios are analyzed with respect to the scenario variables speed, car overlap, left/right positioning, etc. Driving scenarios of subgroups and groups are aggregated according to their weighting factors to generate the global risk-indexing score:

$$GlobalScore = f ( {\sum }_{Scenario groups x} {weight}_{scen {group}_{x}} {\sum }_{Scenarios y} {weight}_{{Scenario}_{y}} {\sum }_{Settings z} {weight}_{i} * {score}_{i} )$$

The risk scoring measuring system and method of the invention are highly consistent and adaptive.

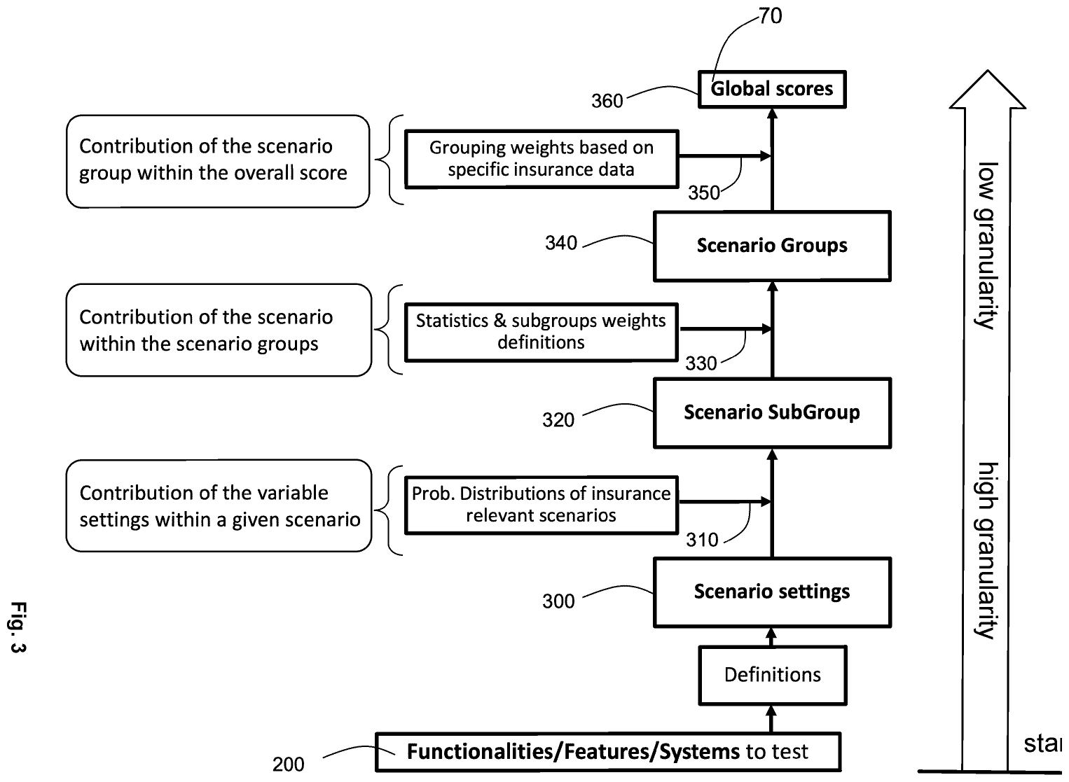

FIG. 4 shows a schematic three-dimensional diagram illustrating a set of measurable scenario characteristics comprising a vehicle variable, an environmental condition variable, a driver variable and an ADAS variable as used for the risk scoring measuring system and method of the present invention. The vehicle variables are tested by a multi-dimensional test matrix. The approach of multi-dimensional test matrix is a theoretical-physics inspired approach accounting for varying multiple scenarios and multiple configurations. For the purpose of demonstrating the multi-dimensional nature of the test setting, FIG. 4 shows a development of ADAS functionalities over time. The center of the coordinate system represents the time zero. Time horizon circles 410 indicate different time periods from the time zero. A current version of an ADAS functionality 200, for example an Automatic emergency braking functionality, is located near the center of the coordinate system. The ADAS functionality 200 technically advances over time and evolves into future versions 200′, 200″, 200′″ and 200″″′ of the ADAS functionality 200. The time horizon circles 410 around the center represent moving boundary conditions of ADAS functionalities testing and reflect the natural tendency of ADAS technology to change and improve. Driving scenarios comprising the ADAS functionality 200 and its future versions 200′, 200”, 200′″ and 200″″′ are represent by a set of measurable scenario variables 410 on the same time horizon circle. As the ADAS functionality 200 advances the set of measurable scenario variables 410, 410′, 410”, etc. may vary over time. The radially extending arrow 420 represents a 3-dimensional pointer in a 2-dimensional space which accounts for the translation of a given variable in time. Accordingly, the risk-indexing score is indicated in a 2-dimensional space defined by a linear axis indicating technologically advancing versions 200′, 200″, 200′″ and 200″″′ of the ADAS functionality and a circular axis indicating measurable scenario variables of driving scenarios comprising said future versions of the ADAS functionality. The 3-dimensional pointer in the 2-dimensional space indicates a time of the technologically advancing versions of an ADAS functionality along the time axis represented by the time horizon. The adaptivity of the testing approach guarantees up-to-date risk-indexing score. The inventive risk scoring measuring system of the invention provides accurate risk-indexing scores for risk transfer processes for vehicles with new ADAS functionalities on from their first day on the roads.

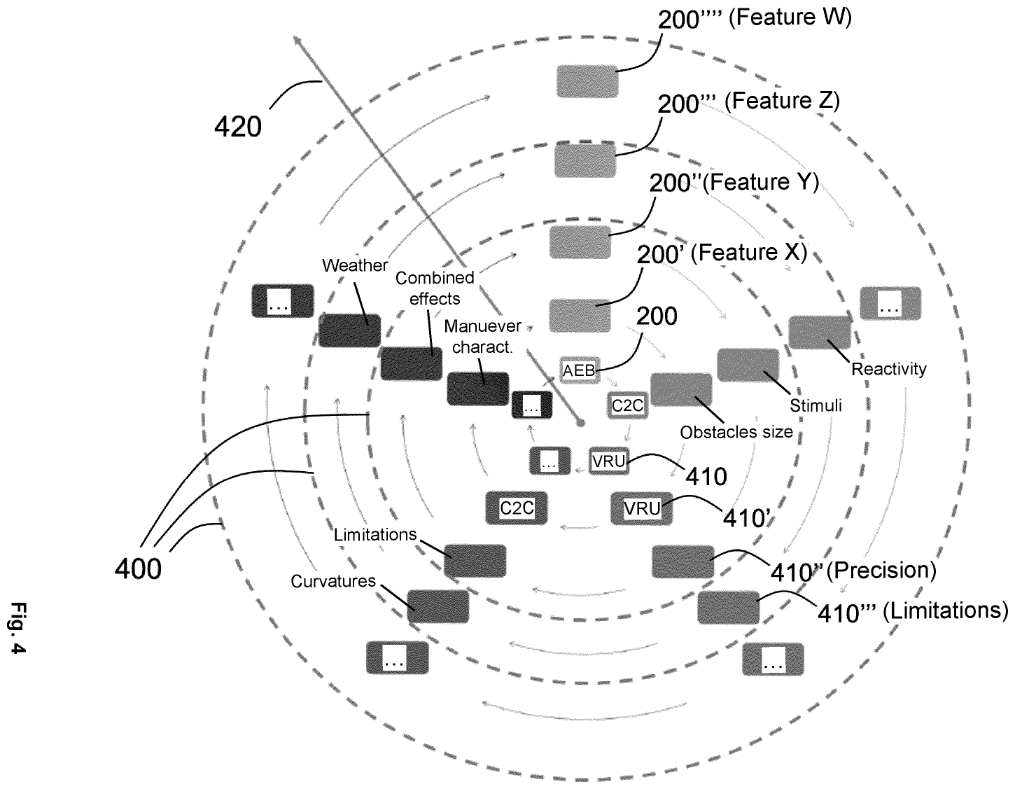

FIG. 5 depicts a schematic illustration showing an example test setting for measuring sets of measurable scenario characteristics of various driving scenarios, the test setting comprising several testing protocols for measuring values of the measurable scenario characteristics as used for the risk scoring measuring system and method of the present invention. FIG. 5 illustrates several exemplary driving scenarios, which for example may be summarized in a subgroup. A warning driving scenario 500 comprises the scenario characteristics “warning” having the variable values “yes” for a warning has been issued, “no” for no warning has been issued, “inception time” for the time when the warning has been issued, and “inception distance” for the distance to an obstacle at which the warning has been issued. An ADAS activation scenario 510 comprises the scenario characteristics “ADAS activation” having the variable values “yes” for ADAS is activated, “no” for ADAS is not activate, “partially” for ADAS has been partially activated, “inception time” for the time when the ADAS has been activated, and “inception distance” for the distance to an obstacle at which the ADAS has been activated. A speed driving scenario 520 comprises the scenario characteristics “speeds” having the variable values “impact” for speed at time of impact, “At point x” for a speed at a point x, and “computed” for a simulated speed. In a similar manner further driving scenarios 530, 540 and 550 can be determined for weather condition scenarios, roads condition scenarios, etc. Interrelation arrows 560 illustrate the interaction and interrelation of the driving scenarios and associated variable values. The relevance of each of the scenarios for generating an accurate risk-indexing score may increase or decrease or even be multiplied by grouping the scenarios.

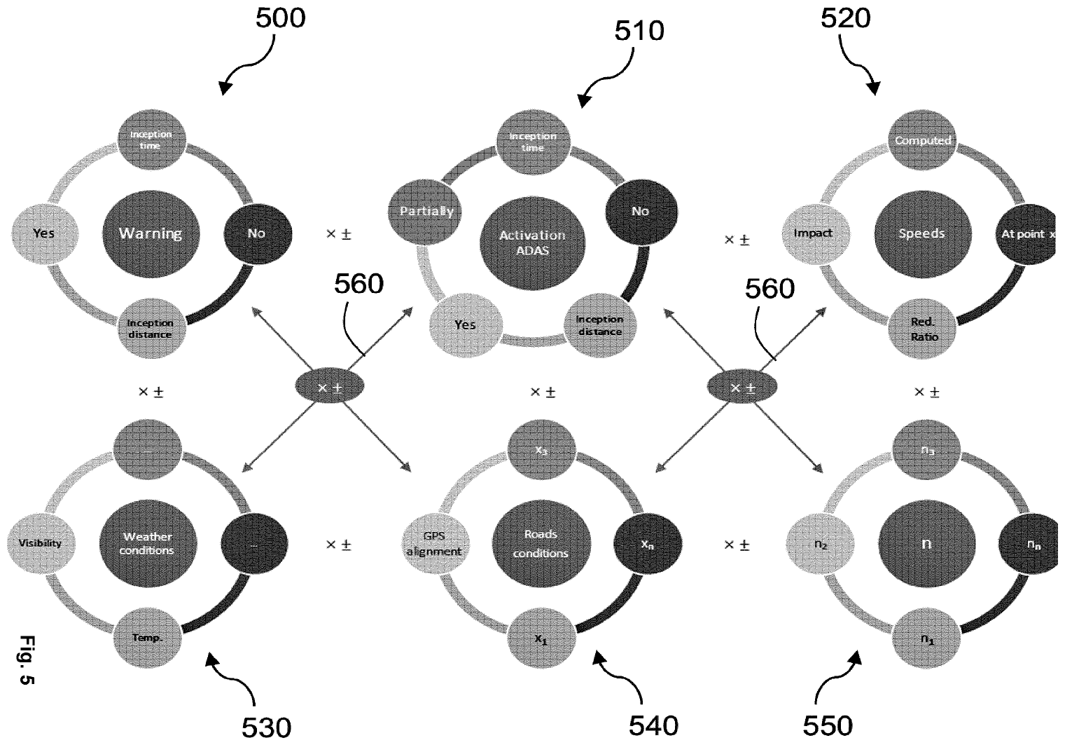

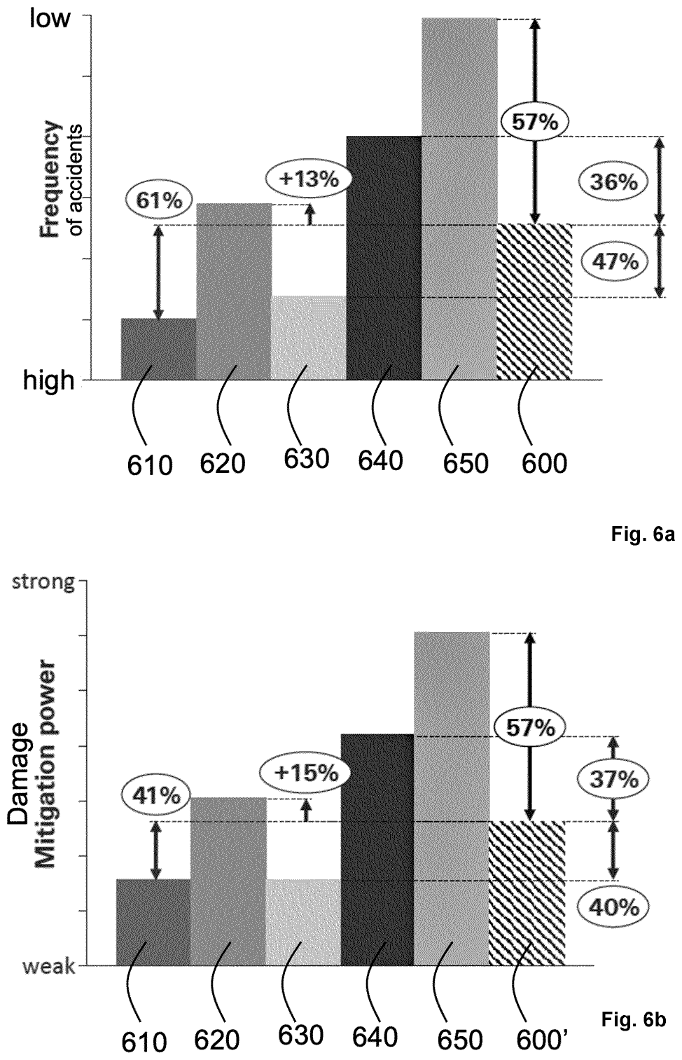

FIG. 6a shows a diagram schematically illustrating a performance for vehicle models with respect to frequency of accidents for the same driving scenarios. The diagram indicates a frequency of accidents on the y-axis starting from a high frequency to a low frequency, and various vehicle models on the x-axis. The frequency ranges from weak to strong. FIG. 6b shows a diagram schematically illustrating a performance for vehicle models with respect to severity of damage for the same driving scenarios. The diagram indicates a severity of damage on the y-axis in form of damage mitigation power and the same various vehicle models on the x-axis. A median bar 600, 600′ indicates a statistical median of the accident frequencies and the mitigation power, respectively, for five vehicle models. The five models differ with respect to their vehicle variables and ADAS variables. The first vehicle model 610 has a 61% higher accident frequency and a 41% weaker damage mitigation power than the median. The second vehicle model 620 has a 13% lower accident frequency and a 15% stronger damage mitigation power than the median. The third vehicle model 630 has a 47% higher accident frequency and a 40% weaker damage mitigation power than the median. The fourth vehicle model 640 has a 36% lower accident frequency and a 37% stronger damage mitigation power than the median. The fifth vehicle model 650 has a 57% lower accident frequency and 57% stronger damage mitigation power than the median. The fifth vehicle model 650 is an exceptional performer both in terms of frequency and severity compared to the other vehicle models. Vehicle models 610 and 630 lack in terms of performance mostly in the frequency domain. The diagrams of FIGS. 6a and 6b illustrate the relation of vehicle characteristics and their contribution to accident probability values by quantifying accident frequency and damage severity. The quantified values of accident frequency and damage severity as available for historic accident and driving scenarios allows for quantitative assessment of ADAS vehicles comprising the same or similar vehicle variable values. Further, the values of accident frequency and damage severity can serve as a basis for defining weighting factors for driving scenarios, as described above.

FIG. 7 shows a diagram schematically illustrating a distribution of accident frequency and damage severity for exemplary driving scenarios differing in the speed of the vehicle according to statistical accidentology. For a low speed driving scenarios 700 with a speed of 25-35 km/h the frequency of accidents is low and the severity of damage is also low. In contrast to that, for a high speed driving scenario 720 with a speed of 105-115 km/h the frequency of accidents is low but the severity of damage is very high. Most accidents happen for medium speed driving scenarios 710 with a speed of 50-80 km/h, accordingly the frequency of accidents is high. However, the severity of damage is in a medium range. Accordingly, weighing factors for low speed driving scenarios, medium speed driving scenarios and high speed driving scenarios can be derived from statistical accidentology and applied in the electronic risk scoring measuring method for measuring a risk-indexing score indicating an accident probability value of the invention. In the same way other statistical accidentology models can be used to define weighting factors for driving scenarios based on other differing scenario variables.

The risk scoring measuring system and method of the present invention has, inter alia, the advantage that, it technically allows to measure a physical risk-indexing score for ADAS vehicles which lack historical risk measurement and even for ADAS vehicle with future versions of ADAS functionalities. The risk scoring measuring system and method allows for measuring a risk-transfer factor, that can be calibrated to vehicle specific driving scenarios, and to capture the impact of ADAS in terms of risk-transfer loss frequency and severity. Further, the present invention is able to provide an automated risk scoring measuring system and method for all kinds of applicable risk-transfer systems, as e.g. vehicle or product liability (re-) insurance systems and/or risk-transfer systems related to or depending on partially or fully automated vehicles. Also, the risk scoring measuring system and method of the present invention provides a holistic technical solution that covers the whole range of ADAS functionalities. Further, they are able to provide a dynamic real-time scoring and appropriate physical measurements, as a scalable solution based on scoring structures and data processing allowing to adapt to other fields of automated risk-transfer. Finally, the risk scoring measuring system and method of the present invention provides reliable and fast access to quantitative up-to-date risk-indexing scores for risk transfer processes and methods that are available as a service to a user of the system.

### LIST OF REFERENCES

1 Accident risk measuring and accident occurrence frequency forecasting system
2 Motor vehicle
   20 Advanced Driver Assistance System (ADAS)
      200 ADAS functionality
      201 long-range radio wave radar unit
      202 Lidar infrared or laser vision unit
      203 camera system
      204 short/medium-range radio wave radar unit
      205 ultrasonic unit
      206 Geo positioning system
      208 odometrical unit
      210 proprioceptive sensors
      212 computer vision device
      220 detection system
      230 telematics system
      232 interfaces
3 Driving testing system
   31 Simulation structure
4 Data-processing engine/processing unit
   40 Driving scenario module
   41 Forward-looking structure
   42 Test setting module
   44 Scoring module
   46 Weighting module with weighting structure
   48 Aggregator/aggregation module
5 Various driving scenarios
   51 First set of measurable scenario characteristics (emergency braking)
      511 Driver attention variable
      512 Distance to front obstacle variable
      513 ADAS maximum braking deceleration variable
   52 Second set of measurable scenario characteristics (blind spot)
      521 Vicinity movement variable
      522 Speed of vicinity movement variable
      523 ADAS movement warning inception variable
   53 Third set of measurable scenario characteristics (heavy traffic)
      531 Vehicle speed variable
      532 Traffic signage information variable
      533 ADAS cruise control speed reduction variable
6 Test setting
   60 Multi-dimensional test matrix
   61 Emergency braking testing protocol
      611 Driver attention testing protocol
      612 Obstacle testing protocol
      613 ADAS maximum braking deceleration testing protocol
   62 Blind spot testing protocol
      621 Vicinity movement testing
      622 Speed of vicinity movement testing
      623 ADAS movement warning indication testing
   63 Heavy traffic testing protocol
      631 Vehicle speed testing
      632 Traffic signage recognition testing
      633 ADAS cruise control speed reduction testing
   64 Test setting input signal
   68 Testing system output signal
   69 Accident database input signal
8 Accident database
   12 Score signal generator
   14 Multi-dimensional test result signal
      140 Set of emergency braking variable values
         1401 Driver attention value
         1402 Distance to obstacle value
         1403 Maximum braking deceleration value
      141 Set of blind spot variable values
         1411 Vicinity movement value
         1412 Speed of vicinity movement value
         1412 ADAS movement warning indication value
      142 Set of heavy traffic variable values
         1421 Vehicle speed value
         1422 Traffic signage recognition value
         1423 Speed reduction value
   16 Historical information data signal
      160 Set of historic emergency braking values
         1601 Historic driver attention value
         1602 Historic distance to obstacle value
         1603 Historic maximum braking deceleration
      161 Set of historic blind spot variable values
         1611 Historic vicinity movement value
         1612 Historic speed of vicinity movement value
         1613 Historic movement warning indication value
      162 Set of historic heavy traffic variable values
         1621 Historic vehicle speed value
         1622 Historic traffic signage recognition value
         1623 Historic speed reduction value
      163 Frequency of historic emergency braking accidents measure
      164 Severity of emergency braking damage measure
      165 Frequency of historic blind spot accidents measure
      166 Severity of historic blind spot damage measure
      167 Frequency of historic heavy traffic accidents measure
      168 Severity of historic heavy traffic damage measure
   70 Risk-indexing score
   80 Data administration structure
   90 Data transmission network
      91 Cellular mobile network
      92 Satellite transmission line
   100 Inquiry input data
   300 Definition step
   310 Risk transfer analysis step
   320 Subgroup step
   330 Subgroup analysis step
   340 Group step
   350 Group analysis step
   360 Score indexing step
   200′, 200″, 200′″ Future versions of ADAS functionality
   400 Time horizon circles
   410, 410′, 410″ Measurable scenario variables
   420 3-dimensional pointer
   500 Warning driving scenario
   510 ADAS activation scenario
   520 Speed driving scenario
   530 Weather condition driving scenario
   540 Roads condition driving scenario
   550 Further driving scenario
   560 Scenario interrelation arrow
   600 Median of the accident frequencies
   600′ Median of mitigation power
   610 First vehicle model
   620 Second vehicle model
   630 Third vehicle model
   640 Fourth vehicle model
   650 Fifth vehicle model
   700 Low speed driving scenario
   710 Medium speed driving scenario
   720 High speed driving scenario

1. An electronic automotive accident-risk measuring system for accidentology-based measuring of accident risk-indexing score values for a new motor vehicle providing a measured and/or forecasted accident probability value for a future occurrence probability of an accident event having a measurable physical impact to the motor vehicle, the motor vehicle being equipped with an Advanced Driver Assistance System (ADAS), wherein the electronic automotive accident-risk measuring system at least comprises a driving testing system, an accident database for storing accident measuring parameter values, a data-processing engine and an electronic score signal generator, wherein the data-processing engine comprises a driving scenario module configured for determining various driving scenarios for the motor vehicle by defining a set of measurable scenario characteristics, wherein the measurable scenario characteristics at least comprise a vehicle parameter and/or an environmental condition parameter and/or a driver parameter and/or an ADAS parameter, and wherein the various driving scenarios at least depend on one ADAS parameter value, and a test setting module configured for determining a test setting for measuring the set of measurable scenario characteristics of each of the various driving scenarios by the driving testing system, wherein the test setting is defined by at least one testing protocol transmitted to the driving testing system, which provides measured values of the measurable scenario characteristics as a test result signal according to the test setting, wherein the test setting of the test setting module includes a multidimensional test matrix, which includes a testing protocol for each of the measurable scenario characteristics of each of the various driving scenarios, and the test result signal is a multi-dimensional test result signal including test result data for each of the measured scenario characteristics of each of the various driving scenarios, in that the data-processing engine comprises a scoring module generating the accident risk-indexing score by receiving the multi-dimensional test result signal from the test setting module or the driving testing system, and receiving a historical data information signal from the accident database, wherein the historical information data signal indicates a probability of occurrence of an accident and/or a damage magnitude for one or more historic driving scenarios, which at least partially comprise the measured scenario characteristics of one or more of the various driving scenarios as indicated in the multi-dimensional test result signal, wherein the historical data provide a quantified measure of frequency of accidents and/or severity of damage associated to the various driving scenarios, and in that the scoring module comprises a scoring structure with a weighting structure for weighting the multi-dimensional test result data based on the historical data information signal with respect to a contribution of each of the various driving scenarios to the accident probability value and an aggregator aggregating the weighted multi-dimensional test result data of the various driving scenarios to generate the risk-indexing score for the motor vehicle.

2. The electronic automotive accident-risk measuring system for measuring a risk-indexing score according to claim 1, wherein the at least one ADAS variable of a driving scenario is characterizing a ADAS functionality of the Advanced Driver Assistance System selected from a group of ADAS functionalities at least including autonomous emergency braking, parking assistance, lane keep assistance, lane change assistance, steering assistance, autonomous headlights, automatic emergency steering, cross traffic alert, adaptive cruise control, blind spot detection, crosswind stabilization, driver monitoring and pedestrian detection/avoidance.

3. The electronic automotive accident-risk measuring system for measuring a risk-indexing score according to claim 1, wherein the at least one testing protocol of the test setting is selected from a group of testing protocols at least measuring the variable values of speed reduction, impact/final speed, impact position, braking distance, warning inception, ADAS feature inception, maximum braking deceleration, maximum braking time and speed range for brake activation.

4. The electronic automotive accident-risk measuring risk scoring system for measuring a risk-indexing score according to claim 1, wherein the driving testing system comprises a driving detection system with a plurality of scenario variable detectors in form of a long-range radio wave radar unit, a Lidar infrared unit, a laser vision unit, a short/medium-range radio wave radar unit, an ultrasonic unit, a geo positioning system unit and/or a camera system for measuring scenario variable values.

5. The electronic automotive accident-risk measuring system for measuring a risk-indexing score according to claim 1, wherein the driving testing system comprises a telematics system for providing telematics data capturing measures of the scenario variable detectors, the telematics system comprising a telematics circuit associated with the scenario variable detectors for transmitting measured scenario variable values.

6. The electronic automotive accident-risk measuring risk scoring system for measuring a risk-indexing score according to claim 1, wherein a number of dimensions of the multi-dimensional test matrix equals a number of measurable scenario characteristics of the sets of measurable scenario characteristics of the various driving scenarios.

7. The electronic automotive accident-risk measuring risk scoring system for measuring a risk-indexing score according to claim 1, wherein the test setting module and/or the driving testing system comprises a simulation structure for simulating at least one driving test according to the at least one testing protocol for simulating testing of at least one measurable scenario characteristics and generating a measured value for the at least one measurable scenario characteristics for the multidimensional test result signal.

8. The electronic automotive accident-risk measuring system for measuring a risk-indexing score according to claim 1, wherein a forward-looking structure anticipates at least one future version of at least one ADAS functionality of the Advanced Driver Assistance System for forecasting a frequency of accidents and/or severity of damage for a driving scenario including the at least one future version of at least one ADAS functionality.

9. The electronic automotive accident-risk measuring system for measuring a risk-indexing score according to the claim 8, wherein the forward-looking structure anticipates a future version of a ADAS functionality of the Advanced Driver Assistance System based on extrapolation of advancement of driving assistance of previous versions of said ADAS functionality.

10. The electronic automotive accident-risk measuring system for measuring a risk-indexing score according to claim 8, wherein the forward-looking structure anticipates a future version of a ADAS functionality by simulating advancement of driving assistance of previous versions of said ADAS functionality, wherein the simulation captures historic real-world data of driving scenarios including the simulated scenario characteristics.

11. The electronic automotive accident-risk measuring risk scoring system for measuring a risk-indexing score according to claim 1, wherein the risk-indexing score is indicated in a 2-dimensional space defined by a linear axis indicating technologically advancing versions of an ADAS functionality and a circular axis indicating measurable scenario characteristics of driving scenarios comprising said versions of an ADAS functionality, wherein a 3-dimensional pointer in the 2-dimensional space indicates a time of the technologically advancing versions of an ADAS functionality along a time axis.

12. An electronic risk scoring measuring method for measuring a risk indexing score indicating an accident probability value for an occurrence of an accident event having a physical impact with a measurable damage to a motor vehicle provided with an Advanced Driver Assistance System (ADAS) and/or a driver of said motor vehicle, wherein the measuring method comprises the steps of determining various driving scenarios for the motor vehicle by defining a set of measurable scenario characteristics, wherein a measurable scenario characteristics characterizes a motor vehicle variable, an environmental condition variable, a driver variable and/or an ADAS variable, wherein the driving scenarios include at least one ADAS variable, and determining a test setting for measuring the set of measurable scenario characteristics of each of the various driving scenarios, wherein the test setting includes a multi-dimensional test matrix, which includes a testing protocol for each of the measurable scenario characteristics of each of the various driving scenarios, transmitting the test setting to a driving testing system and/or a simulation structure and measuring the set of measurable scenario characteristics of each of the various driving scenarios by the driving testing system and/or a simulation structure, which measure values of the measurable scenario characteristics according to the test setting and provides a test result signal as a multi-dimensional test result signal including test result data for each of the measured scenario characteristics of each of the various driving scenarios, receiving the multi-dimensional test result signal from the test setting module or the driving testing system and a historical data information signal from an accident database in a scoring module for generating the risk-indexing score, wherein the historical information data signal indicates a probability of occurrence of an accident and/or a damage magnitude for one or more historic driving scenarios, which at least partially comprise the measured scenario characteristics of one or more of the various driving scenarios as indicated in the multi-dimensional test result signal, and the historical data provide a quantified measure of frequency of accidents and/or severity of damage associated to the various driving scenarios, weighting the multi-dimensional test result data based on the historical information data signal with respect to a contribution of each of the various driving scenarios to the accident probability value and aggregating the weighted multidimensional test result data of the various driving scenarios to define an aggregated risk-indexing score for the motor vehicle.

13. The electronic risk scoring measuring method according to claim 12, wherein the historical data information signal provides historical data of a quantified measure of frequency of accidents and/or severity of damage for historic scenario characteristics values which deviate +/−5% from the measured scenario variable values.

14. The electronic risk scoring measuring method according to claim 12, wherein for the weighting of the multi-dimensional test result data the quantified measure of frequency of accidents and/or severity of damage associated to the various driving scenarios is assigned a weighting factor according to a magnitude of the frequency measure and/or a magnitude of the damage severity measure.

15. The electronic risk scoring measuring method according to claim 12, wherein the historical data information signal provides historical data of a quantified measure of frequency of accidents and/or severity of damage for historic scenario characteristics values which deviate +/−2% from the measured scenario variable values.
